(19) United States
(12) Patent Application Publication
(10) Pub. No.: US 2014/0167646 A1
(43) Pub. Date: Jun. 19, 2014

(54) POLYCHROMATIC SOLID-STATE LIGHT SOURCES FOR THE CONTROL OF COLOUR SATURATION OF ILLUMINATED SURFACES

(71) Applicants: Arturas Zukauskas, Vilnius (LT); Rimantas Vaicekauskas, Vilnius (LT); Pranciskus Vitta, Vilnius (LT); Arunas Tuzikas, Vilnius (LT); Michael Shur, Latham, NY (US)

(72) Inventors: Arturas Zukauskas, Vilnius (LT); Rimantas Vaicekauskas, Vilnius (LT); Pranciskus Vitta, Vilnius (LT); Arunas Tuzikas, Vilnius (LT); Michael Shur, Latham, NY (US)

(73) Assignee: VILNIAUS UNIVERSITETAS, Vilnius (LT)

(21) Appl. No.: 14/232,400

(22) PCT Filed: Aug. 19, 2011
(86) PCT No.: PCT/LT2011/000011

§ 371 Date: Jan. 13, 2014

(30) Foreign Application Priority Data
Jul. 12, 2011 (LT) 2011 063

(51) Int. Cl. H05B 33/08

(52) U.S. Cl. CPC H05B 33/0857
USPC 315/297

(57) ABSTRACT

Polychromatic light sources of white light are composed of at least two different coloured emitters, such as groups of light-emitting diodes (LEDs). Disclosed are the spectral power distributions and relative partial radiant fluxes of the coloured emitters that allow controlling the colour saturating ability of the generated light, namely, the ability to render colours with increased saturation and the ability to render colours with decreased saturation. Also disclosed is a method for dynamical tailoring the colour saturating ability of the generated light.

### TECHNICAL FIELD

The present invention relates to polychromatic sources of white light, which are composed of at least two groups of coloured emitters, such as light-emitting diodes (LEDs) or lasers, having different spectral power distributions (SPDs) and relative partial radiant fluxes (RPRFs). Such sources are designed for generating white light with a predetermined correlated colour temperature (CCT) and a predetermined lowest luminous efficacy of radiation (LER) or lowest luminous efficiency in such a way that the ability to saturate colours of illuminated surfaces can be controlled. In particular, embodiments of the present invention describe dichromatic, trichromatic and tetrachromatic sources, which in comparison with a reference light source, such as a blackbody or daylight-phase illuminant, render colours of at least predetermined fraction of a large number of test colour samples with increased (decreased) chromatic saturation, whereas colours of at most another predetermined fraction of test samples are rendered with decreased (increased) chromatic saturation. A method of composing SPDs of narrow-band emissions for the control of colour saturating ability is described, spectral compositions of white light with different colour saturating ability are disclosed, and a light source with dynamically tailored colour saturating ability is introduced.

### DEFINITIONS

LED—light emitting diode, which converts electric power to light due to injection electroluminescence.

Colour space—a model for mathematical representation of a set of colours.

Munsell samples—a set of colour samples introduced by Munsell and then updated, such that each sample is characterized by the hue, value (lightness scale), and chroma (colour purity/saturation scale).

Colour rendered with increased saturation—the colour of a test colour sample, which, when a reference light source is replaced by a source under test, has a chromaticity shift stretching out of a region on a chromaticity diagram, which contain all colours that are indistinguishable, to the average human eye, from a colour at a centre of the region, in the direction of increased chroma.

Colour rendered with decreased saturation—the colour of a test colour sample, which, when a reference light source is replaced by a source under test, has a chromaticity shift stretching out of a region on a chromaticity diagram, which contain all colours that are indistinguishable, to the average human eye, from a colour at a centre of the region, in the direction of decreased chroma.

MacAdams ellipses—the regions on the chromaticity plane of a colour space that contain all colours which are almost indistinguishable, to the average human eye, from the colour at the centre of the region.

### BACKGROUND ART

White light can be composed of coloured components using the principle of colour mixing, which relies on three colour-mixing equations. The colour mixing principle implies that for compositions containing only two coloured components, such as blue and yellow or red and blue-green, white light with a predetermined CCT can be obtained when the coloured components complement each other, i.e. both their hues and RPRFs are exactly matched in a particular way. A set of three coloured components, such as red, green, and blue, can be used for composing white light with different CCTs and different colour rendition characteristics depending on the selection of the SPDs and RPRFs of each group of emitters. When four or more appropriate coloured components are employed, the three colour mixing equations yield no single solution for a predetermined chromaticity of white light, i.e. white light of the same chromaticity can be obtained within an infinite number of SPDs containing blends of coloured components with various RPRFs. This implies that for a particular set of four and more coloured primary sources, colour rendition characteristics of white light can be varied.

Tailoring the SPD of white light within a single lamp became feasible with the development of solid-state lighting technology based on LEDs. LEDs employ the principle of injection electroluminescence, which yields narrow-band emission with the spectral peak position controlled by varying the chemical contents and thickness of the light-generating (active) layers. Some LEDs also employ partial or complete conversion of electroluminescence to other wavelengths. LEDs are available with many colours, have small dimensions, and their principle of operation allows varying the output flux by driving current. Assembling LEDs with different chromaticity into arrays and using electronic circuits for the control of partial fluxes of each group of emitters and using optical means for the uniform distribution of the colour-mixed emission allows for the development of versatile sources of light with predetermined or dynamically controlled colour rendition properties.

Such versatility in properties of illumination has been considered in numerous patents and publications of prior art. D. A. Doughty et al. (U.S. Pat. No. 5,851,063, 1998) proposed a source of light composed of 4 groups of coloured LEDs with the wavelengths of the LEDs selected such that the general colour rendering index (Rₐ), as defined by the International Commission of Illumination (Commission Internationale de l′Éclairage, CIE) (CIE Publication No. 13.3, 1995) is at least approximately 80 or 85. H. F. Börner et al. (U.S. Pat. No. 6,234,645, 2001) disclosed a lighting system composed of four LEDs with the luminous efficacy and Rₐ having magnitudes in excess of predetermined values. In the subsequent journal publications, the trade-offs between LER and the general colour rendering index, as well as the optimal wavelengths of LEDs for tetrachromatic and pentachromatic sources of light were established (A. Zukauskas et al., Proc. SPIE 4445, 148, 2001; A. Zukauskas et al., Appl. Phys. Lett., 80, 234, 2002; A. Zukauskas et al., Int. J. High Speed Electron. Syst. 12, 429, 2002). M. Shimizu et al. (U.S. Pat. No. 6,817,735, 2004 and U.S. Pat. No. 7,008,078, 2006) disclosed tetrachromatic solid-state sources of white light with the general colour rendering index of at least 90 and with improved colour saturating ability (an increased gamut area of chromaticities of four CIE standard test colour samples). I. Ashdown and M. Salsbury (U.S. Patent Application No 2008/0013314, 2008) disclosed a light source containing four or more light-emitting elements with the partial radiant fluxes being tuned in such a way that a trade-off between qualitative characteristics of illumination, such as Rₐ or Colour Quality Scale (CQS; W. Davis and Y. Ohno, Proc. SPIE 5941, 59411G, 2005; W. Davis and Y. Ohno, Opt. Eng. 49, 033602, 2010), and quantitative characteristics, such as luminous efficacy, and output power, could be performed.

However, the above approaches to the optimization of sources of white light containing multiple coloured components are far from exploiting the advantages of solid-state lighting in versatility of colour quality to a full extent. Most approaches rely on solely colour fidelity characteristics of white light, such as the general colour rendering index, or use combined characteristics, which integrate the ability to render colours with high fidelity and colour saturating ability. Also, the use of the general colour rendering index, as a single indicator of quality of light, contradicts visual ranking of solid-state sources of light (N. Narendran and L. Deng, Proc. SPIE 4776, 61, 2002; Y. Nakano et al., in Proc. AIC Colour 05, Granada, Spain, 2005, p 1625) and is now considered obsolete (CIE Publication No 177, 2007). One of the reasons of the inappropriateness of Rₐ is the disregard of colour distortions of different types. However distortions that increase colour saturation are known to be visually tolerated or even preferred. Another reason is the impossibility of the use of a large number of test colour samples in the Rₐ assessment procedure because the average of the colour shifts used for Rₐ, is ambiguous when the samples have very different chromatic saturation. The attempts to mitigate colour saturation problem in the assessment of colour quality of a light source by either simultaneously increasing both Rₐ and gamut area for a small number of test colour samples or by tolerating colour-saturating distortions (CQS approach) are unable to fully describe colour quality of illumination. The metrics of colour quality must at least account for two distinct colour rendition characteristics: the ability to make colours appear “natural” (colour fidelity) and the ability to make colours appear “vivid” and easy to distinguish (colour saturating) (M. S. Rea and J. P. Freyssinier-Nova, Colour Res. Appl. 33, 192, 2008; A. Zukauskas et al., IEEE J. Sel. Top. Quantum Electron. 15, 1753, 2009). These two colour-quality characteristics are mutually opposing and can be optimized only within a trade-off, since colours that appear “natural” do not have increased chromatic saturation and vice versa.

An advanced approach to colour quality of light sources relies on analyzing colour shift vectors for any number of different test colour samples and sorting these samples to several groups depending on a type of the colour distortion that occurs when the reference source is replaced by that under assessment (A. Zukauskas et al., IEEE J. Sel. Top. Quantum Electron. 15, 1753, 2009; A. Zukauskas et al., J. Phys. D Appl. Phys. 43, 354006, 2010). In this statistical approach, which clearly distinguishes between different colour rendition characteristics, the colour shift vectors are computationally sorted depending on their behaviour in respect of experimentally established just perceived differences of chromaticity and luminance. Then the relative numbers (percentages) of test colour samples that exhibit colour distortions of various types are defined as statistical colour quality indices: Colour Fidelity Index (CFI; percentage of the test samples having the colour shifts smaller than perceived chromaticity differences), Colour Saturation Index (CSI; percentage of the test samples having the colour shift vectors with a perceivable increase in chromatic saturation), and Colour Dulling Index (CDI; percentage of the test samples having the colour shift vectors with a perceivable decrease in chromatic saturation).

The statistical approach has been employed for the maximization of CFI of polychromatic white lamps composed of coloured LEDs (A. Zukauskas et al. PCT Patent Application publication No WO 2009102745) as well as of white LEDs with both complete and partial conversion of short-wavelength radiation in phosphors (A. Zukauskas et al. PCT Patent Application publication No WO2009117286 and A. Zukauskas et al. PCT Patent application publication No WO2009117287, respectively). The same approach has been used for establishing the principle design rules for LED-based lamps with maximized CSI (A. Zukauskas et al. Opt. Express 18, 2287, 2010). In particular, a composite light source with the highest CSI was shown to contain three certain narrow-band colour components (A. Zukauskas et al., Opt. Express 18, 2287, 2010), whereas the use of other blends of two or three colour components can result in a high CDI (A. Zukauskas et al., J. Phys. D Appl. Phys. 43, 354006, 2010).

The prior art closest to the proposed sources of white light is the aforementioned polychromatic white lamp composed of coloured LEDs for the maximization of colour fidelity considered in the PCT Patent Application publication No WO2009102745. However, this lamp lacks control over colour saturating ability, which is one of the most important colour rendition characteristics of light sources.

### SUMMARY OF THE INVENTION

The main aim of the invention is to develop a polychromatic source of white light with a versatile control of colour saturating ability. According to the best knowledge of the Applicant and inventors, prior to the disclosure of the present invention:

(a) SPDs of light sources composed of multiple groups of coloured emitters have not been optimized in such a way that, e.g., a high number of surface colours were rendered with increased chromatic saturation, while a small number of surface colours were rendered with decreased chromatic saturation, or vice versa, a high number of surface colours were rendered with decreased chromatic saturation, while a small number of surface colours were rendered with increased chromatic saturation;
(b) Polychromatic light sources with the dynamical tailoring of colour saturating ability have been not introduced;
(c) SPDs of LEDs that are most appropriate for composing polychromatic light sources with controlled colour saturating ability have been not selected;
(d) RPRFs generated by coloured LEDs with multiple SPDs within light sources having different colour saturating ability have been not determined.

Main aspects of the present invention relate to polychromatic sources of white light, which are composed of at least two groups of coloured emitters, having different SPDs, such as provided by LEDs. Such sources are optimized through the selection of the most appropriate SPDs and RPRFs of each group of coloured emitters in such a way that the colour saturating ability of white light with a predetermined CCT could be established and controlled by setting a desired ratio between the number of surface colours that appear as having increased and decreased chromatic saturation, respectively.

A first aspect of the invention provides light sources, having a predetermined CCT and a predetermined lowest LER or lowest luminous efficiency, comprising at least two groups of coloured emitters, the SPDs and RPRFs generated by each group of emitters being established such that in comparison with a reference light source, when each of more than fifteen test colour samples (resolved by an average human eye as different) is illuminated, the colour saturating ability of illumination is established such that: (a) colours of at least of a predetermined fraction of the test colour samples are rendered with increased chromatic saturation; and (b) colours of at most of another predetermined fraction of the test colour samples are rendered with decreased chromatic saturation. Alternatively, the colour saturating ability of illumination is established such that: (a) colours of at least of a predetermined fraction of the test colour samples are rendered with decreased chromatic saturation; and (b) colours of at most of another predetermined fraction of the test colour samples are rendered with increased chromatic saturation.

A second aspect of the invention provides a light source, having a predetermined CCT, comprising at least four groups of coloured emitters having predetermined SPDs, with the RPRFs generated by each group of emitters being dynamically varied in such a way that in comparison with a reference light source, when each of more than fifteen test colour samples (resolved by an average human eye as different) is illuminated, the colour saturating ability of the source is tailored, i.e. the number of the test colour samples that are rendered with decreased chromatic saturation decreases and the number of the test colour samples that are rendered with increased chromatic saturation increases. Alternatively, the number of the test colour samples that are rendered with decreased chromatic saturation increases and the number of the test colour samples that are rendered with increased chromatic saturation decreases.

Other aspects of the invention may include means of controlling RPRFs generated by each group of coloured emitters, means of uniform distribution of light generated by each group of emitters and/or means to implement some or all of the features described herein. The illustrative aspects of the invention are designed to solve one or more of the problems herein described.

More specifically the present invention covers a solid-state light source, having a predetermined correlated colour temperature and a predetermined lowest luminous efficacy of radiation or lowest luminous efficiency, comprising at least one package of at least two groups of visible-light emitters having different spectral power distributions and individual relative partial radiant fluxes; an electronic circuit for the control of the average driving current of each group of emitters and/or the number of the emitters lighted on within a group; and a component for uniformly distributing radiation from the different groups of emitters over an illuminated object, wherein the spectral power distributions and relative partial radiant fluxes generated by each group of emitters are such that, in comparison with a reference light source, when each of more than fifteen test colour samples resolved by an average human eye as different is illuminated, the colour saturating ability is controlled in such a way that both the fraction of the test colour samples that are rendered with increased saturation and the fraction of the test colour samples that are rendered with decreased saturation are predetermined and/or are dynamically traded off.

The light sources described in the present invention are characterised by the correlated colour temperature in the range of around 2500 to 10000 K. In preferred embodiments of the present invention, the colour saturating ability of said light sources is estimated with a chromatic adaptation of human vision taken into account; and/or the emitters of light sources comprise light emitting diodes, which emit light due to injection electroluminescence in semiconductor junctions or due to partial or complete conversion of injection electroluminescence in wavelength converters containing phosphors.
One embodiment of the present invention describes the colour-saturating light source, which comprises at least three groups of visible-light emitters, wherein the spectral power distributions and relative partial radiant fluxes generated by each said group of emitters are such that, in comparison with a reference light source, when each of more than fifteen test colour samples resolved by an average human eye as different is illuminated:
(a) colours of at least a predetermined fraction of the test colour samples are rendered with increased saturation; and
(b) colours of at most another predetermined fraction of the test colour samples are rendered with decreased saturation.
   Alternatively, the relative partial radiant fluxes generated by each said group of emitters are such that the difference of the fraction of the test colour samples that are rendered with increased saturation and the fraction of the test colour samples that are rendered with decreased saturation is maximized.
   In embodiments of the colour-saturating light source, the source has correlated colour temperature in the interval of 2700-6500 K and luminous efficacy of radiation of at least 250 lm/W and comprises three groups of coloured light-emitting diodes with the average band width around 30 nm, having peak wavelengths within the intervals of around 408-486 nm, 509-553 nm, and 605-642 nm, when colours of at least 60% of more than 1000 different test colour samples are rendered with increased saturation and colours of at most 4% of the test colour samples are rendered with decreased saturation.
   In the preferred embodiment of the colour-saturating light source, said three groups of coloured light-emitting diodes comprise blue electroluminescent InGaN light-emitting diodes with the peak wavelength of about 452 nm and band width of about 20 nm; green electroluminescent InGaN light-emitting diodes with the peak wavelength of about 523 nm and band width of about 32 nm; and red electroluminescent AlGaInP light-emitting diodes with the peak wavelength of about 625 nm and band width of about 15 nm, respectively, wherein for more than 1200 different test colour samples, the fraction of the samples that are rendered with increased saturation is maximized and the fraction of the samples that are rendered with decreased saturation is minimized:
(a) to about 77% and about 1%, respectively, for a correlated colour temperature of 3000 K, by selecting the relative partial radiant fluxes of 0.103, 0.370, and 0.527 generated by said 452-nm, 523-nm, and 625-nm light-emitting diodes, respectively;
(b) to about 70% and about 0%, respectively, for a correlated colour temperature of 4500 K, by selecting the relative partial radiant fluxes of 0.195, 0.401, and 0.405 generated by said 452-nm, 523-nm, and 625-nm light-emitting diodes, respectively;
(c) to about 67% and about 2%, respectively, for a correlated colour temperature of 6500 K, by selecting the relative partial radiant fluxes of 0.283, 0.392, and 0.325 generated by said 452-nm, 523-nm, and 625-nm light-emitting diodes, respectively.
   Another embodiment of the present invention describes the colour-dulling light source, which comprises at least two groups of visible-light emitters, wherein the spectral power distributions and relative partial radiant fluxes generated by each said group of emitters are such that, in comparison with a reference light source, when each of more than fifteen test colour samples resolved by an average human eye as different is illuminated:
(a) colours of at least a predetermined fraction of the test colour samples are rendered with decreased saturation; and
(b) colours of at most another predetermined fraction of the test colour samples are rendered with increased saturation.
   Alternatively, the relative partial radiant fluxes generated by each said group of emitters are such that the difference of the fraction of the test colour samples that are rendered with decreased saturation and the fraction of the test colour samples that are rendered with increased saturation is maximized.
   In embodiments of the colour-dulling light source, the source has correlated colour temperature in the interval of 2700-6500 K and luminous efficacy of radiation of at least 250 lm/W and comprises:
(a) two groups of coloured light-emitting diodes with the average band width around 30 nm, having peak wavelengths within the intervals of around 405-486 nm and 570-585 nm, or
(b) three groups of coloured light-emitting diodes with the average band width around 30 nm, having peak wavelengths within the intervals of around 405-486 nm and 490-560 nm, and 585-600 nm,
   when colours of at least 60% of 1000 different test colour samples are rendered with decreased saturation and of at most 4% of the test colour samples are rendered with increased saturation.
   In the preferred embodiment of the colour-dulling light source, the three groups of coloured light-emitting diodes comprise blue electroluminescent InGaN light-emitting diodes with the peak wavelength of about 452 nm and band width of about 20 nm; green electroluminescent InGaN light-emitting diodes with the peak wavelength of about 523 nm and band width of about 32 nm; and amber electroluminescent AlGaInP light-emitting diodes with the peak wavelength of about 591 nm and band width of about 15 nm, respectively, wherein for more than 1200 different test colour samples, the fraction of the test colour samples that are rendered with decreased saturation is maximized and the fraction of the test colour samples that are rendered with increased saturation is minimized:
(a) to about 67% and 1%, respectively, for a correlated colour temperature of 3000 K, by selecting the relative partial radiant fluxes of 0.154, 0.228, and 0.618 generated by said 452-nm, 523-nm, and 591-nm light-emitting diodes, respectively;
(b) to about 58% and 1%, respectively, for a correlated colour temperature of 4500 K, by selecting the relative partial radiant fluxes of 0.254, 0.308, and 0.438 generated by said 452-nm, 523-nm, and 591-nm light-emitting diodes, respectively;
(c) to about 51% and 0%, respectively, for a correlated colour temperature of 6500 K, by selecting the relative partial radiant fluxes of 0.346, 0.320, and 0.334 generated by said 452-nm, 523-nm, and 591-nm light-emitting diodes, respectively.
   One more embodiment of the present invention describes the light source with low chromatic saturation distortions, which comprises at least three groups of visible-light emitters, wherein the spectral power distributions and relative partial radiant fluxes generated by each said group of emitters are such that, in comparison with a reference light source, when each of more than fifteen test colour samples resolved by an average human eye as different is illuminated:
(a) colours of at most a predetermined fraction of the test colour samples are rendered with decreased saturation; and
(b) colours of at most another predetermined fraction of the test colour samples are rendered with increased saturation.
   Alternatively, the relative partial radiant fluxes generated by each said group of emitters are selected such that both the fractions of the test colour samples that are rendered with increased and decreased chromatic saturation are minimized below a predetermined fraction.
   In embodiments of the light source with low chromatic saturation distortions, the source has correlated colour temperature in the interval of 2700-6500 K and luminous efficacy of radiation of at least 250 lm/W and comprises:
(a) three groups of coloured light-emitting diodes with the average band width around 30 nm, having peak wavelengths within the intervals of around 433-487 nm, 519-562 nm, and 595-637 nm, when the fractions of more than 1200 different test colour samples that are rendered with both decreased saturation and increased saturation are minimized to 14%, or
(b) four groups of coloured light-emitting diodes with the average band width around 30 nm, having peak wavelengths within the intervals of around 434-475 nm, 495-537 nm, 555-590 nm, and 616-653 nm, when the fractions of more than 1200 different test colour samples that are rendered with both decreased saturation and increased saturation are minimized to 2%.
   In the preferred embodiment of the light source with low chromatic saturation distortions, the source comprises three groups of coloured light-emitting diodes, such as blue electroluminescent InGaN light-emitting diodes with the peak wavelength of about 452 nm and band width of about 20 nm; cyan electroluminescent InGaN light-emitting diodes with the peak wavelength of about 512 nm and band width of about 30 nm; and amber phosphor converted InGaN light-emitting diodes with the peak wavelength of about 589 nm and band width of about 70 nm, wherein the fractions of more than 1200 different test colour samples that are rendered with both decreased saturation and increased saturation are minimized to:
(a) about 32% for a correlated colour temperature of 4500 K, by selecting the relative partial radiant fluxes of 0.207, 0.254, and 0.539 generated by said 452-nm, 512-nm, and 589-nm light-emitting diodes, respectively;
(b) about 15% for a correlated colour temperature of 6500 K, by selecting the relative partial radiant fluxes of 0.291, 0.280, and 0.429 generated by said 452-nm, 512-nm, and 589-nm light-emitting diodes, respectively; or
   said light source comprises four groups of coloured light-emitting diodes, such as blue electroluminescent InGaN light-emitting diodes with the peak wavelength of about 452 nm and band width of about 20 nm; green electroluminescent InGaN light-emitting diodes with the peak wavelength of about 523 nm and band width of about 32 nm; amber phosphor converted InGaN light-emitting diodes with the peak wavelength of about 589 nm and band width of about 70 nm; and red AlGaInP light-emitting diodes with the peak wavelength of about 637 nm and band width of about 16 nm, wherein the fractions of more than 1200 different test colour samples that are rendered with both decreased saturation and increased saturation are minimized to:
(c) about 2% for a correlated colour temperature of 3000 K, by selecting the relative partial radiant fluxes of 0.112, 0.2255, 0.421, and 0.242 generated by said 452-nm, 523-nm, 589-nm, and 637-nm light-emitting diodes, respectively;
(d) about 3% for a correlated colour temperature of 4500 K, by selecting the relative partial radiant fluxes of 0.208, 0.283, 0.353, and 0.156 generated by said 452-nm, 523-nm, 589-nm, and 637-nm light-emitting diodes, respectively;
(e) about 4% for a correlated colour temperature of 6500 K, by selecting the relative partial radiant fluxes of 0.300, 0.293, 0.30, 5 and 0.102 generated by said 452-nm, 523-nm, 589-nm, and 637-nm light-emitting diodes, respectively.
   The present invention also covers the polychromatic light source with dynamically tailored colour saturating ability, wherein the relative partial radiant fluxes generated by each group of emitters are synchronously varied in such a way that in comparison with a reference light source, when each of more than fifteen test colour samples resolved by an average human eye as different is illuminated,
(a) the fraction of the test colour samples that are rendered with increased saturation, increases while the fraction of the test colour samples that are rendered with decreased saturation decreases; or
(b) the fraction of the test colour samples that are rendered with increased saturation, decreases while the fraction of the test colour samples that are rendered with decreased saturation increases.
   In embodiments of the light source with dynamically tailored colour saturating ability, the relative partial radiant fluxes generated by each said group of emitters is synchronously varied as a weighted sum of the relative partial radiant fluxes of the corresponding groups of emitters comprised in two light sources, wherein a first source is the above defined colour-saturating light source and a second source is the above defined colour-dulling light source. More specifically, the light source with tailored colour saturating ability has a preselected value of correlated colour temperature in the interval of 2700-6500 K and luminous efficacy of radiation of at least 250 lm/W, wherein the relative partial radiant fluxes generated by each said group of emitters are synchronously varied as a weighted sum of the corresponding relative partial radiant fluxes of the two light sources, wherein the colour-saturating source is composed of three groups of light-emitting diodes and the colour-dulling source is composed of two or three groups of light-emitting diodes, both sources having peak wavelengths within the above defined intervals.
   One preferred embodiment of the dynamically tailored light source describes a source, which has the correlated colour temperature in the interval of 2700-6500 K and luminous efficacy of radiation of at least 250 lm/W and comprises four groups of coloured light-emitting diodes, such as blue InGaN light-emitting diodes with the peak wavelength of about 452 nm and band width of about 20 nm; green InGaN light-emitting diodes with the peak wavelength of about 523 nm and band width of about 32 nm; amber AlGaInP light-emitting diodes with the peak wavelength of about 591 nm and band width of about 15 nm; and red AlGaInP light-emitting diodes with the peak wavelength of about 625 nm and band width of about 15 nm, wherein the relative partial radiant fluxes generated by said each group of light-emitting diodes are synchronously varied as a weighted sum of the corresponding relative partial radiant fluxes of the above defined colour-saturating trichromatic cluster, which is composed of the blue, green, and red light-emitting diodes, and the above defined colour-dulling trichromatic cluster, which is composed of the blue, green, and amber light-emitting diodes, both clusters having the same value of correlated colour temperature.
   Another preferred embodiment of the dynamically tailored light source describes a source, which has correlated colour temperature of about 6042 K and luminous efficacy of radiation of at least 250 lm/W and comprises four groups of light-emitting diodes, such as white dichromatic light-emitting diodes with partial conversion of radiation in phosphor; blue InGaN light-emitting diodes with the peak wavelength of about 452 nm and band width of about 20 nm; green InGaN light-emitting diodes with the peak wavelength of about 523 nm and band width of about 32 nm; and red AlGaInP light-emitting diodes with the peak wavelength of about 637 nm and band width of about 16 nm, wherein the relative partial radiant fluxes generated by each said group of light-emitting diodes are synchronously varied as a weighted sum of the corresponding relative partial radiant fluxes of the white light-emitting diodes and the trichromatic cluster composed of the blue, green, and red light-emitting diodes.
   In any of embodiments of the present invention, visible-light emitters within at least one of said groups are integrated semiconductor chips, wherein the spectral power distribution of the chips is adjusted by tailoring at least one of a chemical composition of an active layer or a thickness of the active layer forming each emitter or a chemical composition of phosphor contained in the wavelength converter or a thickness or shape of the wavelength converter.
   In any of embodiments of the present invention, the light source further comprises:

an electronic circuit for dimming the light source in such a way that the relative partial radiant fluxes generated by each group of emitters are maintained at constant values; and/or

an electronic and/or optoelectronic circuit for estimating the relative partial radiant fluxes generated by each group of emitters; and/or

a computer hardware and software for the control of the electronic circuits in such a way that allows varying correlated colour temperature and the fraction of test colour samples that are rendered with increased or decreased saturation, maintaining a constant luminous output while varying correlated colour temperature and the fraction of test colour samples that are rendered with increased or decreased saturation, dimming, and compensating thermal and aging drifts of each group of light emitters.

The present invention also covers a method for dynamic tailoring the colour saturation ability, wherein white light is generated by mixing emission from at least two sources of white light, having different colour saturation ability as defined above, the spectral power distribution of the mixed emission being synchronously varied as a weighted sum of the spectral power distributions of said constituent sources with variable weight parameters, which control the colour saturating ability.
In the preferred embodiment of the method, white light is generated by mixing emission from two sources of white light, having the same correlated colour temperature and each comprising at least one group of white emitters and/or at least two groups of coloured emitters, the spectral power distribution of the mixed emission, S_{σ}, being synchronously varied as a weighted sum of the spectral power distributions of said two constituent sources, S₁ and S₂, respectively, as

S_{σ}=σS₁+(1−σ)S₂, (1)

where σ is the variable weight parameter.

### BRIEF DESCRIPTION OF THE DRAWINGS

FIG. 1 shows a chromaticity diagram with 20 test colour samples represented by elliptical regions. Each elliptical region contains all the colours visually indistinguishable from a colour at the centre of the region. The vectors show colour shifts of the samples when a reference light source is replaced by that under test.

FIG. 2 shows some SPDs of optimized light sources composed of LEDs with a band width of 30 nm and having a minimal LER of 250 lm/W for three values of CCT (solid line, 3000 K; dashed line, 4500 K; and dotted line 6500 K). The SPDs have predetermined values of CSI in excess of 75% and CDI below 2% for a three-component colour-saturating cluster (part A); CDI in excess of 75% and CSI below 4% for a two-component colour-dulling cluster (part B); CDI in excess of 65% and CSI below 2% for a three-component colour-dulling cluster (part C); both CDI and CSI below 14% for a three-component cluster (part D); and both CDI and CSI below 2% for a four-component cluster (part E).

FIG. 3 shows the SPDs of nine types of actual LEDs used for the optimization of practical polychromatic light sources with controlled colour saturating ability. Solid lines correspond to coloured LEDs; and the dashed line represents a white dichromatic phosphor conversion LED.

FIG. 4 shows some SPDs of optimized light sources composed of actual coloured LEDs for three values of CCT (solid line, 3000 K; dashed line, 4500 K; and dotted line 6500 K). The SPDs have values of CSI in excess of 65% and CDI below 3% for a three-component colour-saturating cluster (part A); CDI in excess of 50% and CSI below 2% for a three-component colour-dulling cluster (part B); both CDI and CSI below 33% for a three-component cluster (part C); and both CDI and CSI below 5% for a four-component cluster (part D).

FIG. 5 shows SPDs and characteristics of a LED-based light source with tailored colour saturating ability as functions of weight parameter a at a CCT of 3000 K. The weight parameter controls the contributions of the red-green-blue and amber-green-blue clusters of LEDs. Parts A, B, and C show SPDs with the highest CDI, with both CSI and CDI low, and with the highest CSI, respectively. Part D shows the variation of colour rendition indices and LER. Part E shows the variation of the RPRFs of the four LEDs.

FIG. 6 shows data similar to that shown in FIG. 5, but for CCT=4500 K.

FIG. 7 shows data similar to that shown in FIG. 5, but for CCT=6500 K.

FIG. 8 shows data similar to that shown in FIG. 5, but for a LED-based light source composed of a dichromatic white phosphor converted LED and a red-green-blue cluster of LEDs at a CCT of 6042 K. Here the weight parameter a controls the contributions of the white LED and cluster.

### DETAILED DESCRIPTION OF THE INVENTION

In accordance with embodiments of the present invention, a white light source having a predetermined CCT is provided. The light source comprises at least two groups of coloured visible-light emitters, each group having emitters with almost identical SPDs, an electronic circuit for the control of the average driving current of each group of emitters and/or the number of the emitters lighted on within a group, and a component for uniformly distributing radiation from the different groups of emitters over an illuminated object. One embodiment of the present invention describes new combinations of the emitter groups with SPDs and RPRFs established such that in comparison with a reference blackbody radiator or daylight-phase illuminant, colours of at least a predetermined fraction of a large set of test colour samples are rendered with increased (decreased) chromatic saturation and colours of at most another predetermined fraction of a large set of test colour samples are rendered with decreased (increased) chromatic saturation. Another embodiment of the present invention describes combinations of at least four preselected coloured visible-light emitter groups with the RPRFs varied in such a way that the colour saturating ability of the composed source is tailored, i.e. the ratio of the fractions of test colour samples with colours rendered with increased chromatic saturation and those rendered with decreased chromatic saturation is varied. The SPDs of the resulting sources of white light differ from distributions optimized using approaches based on the general colour rendering index, colour gamut area, or colour quality scale. As used herein, unless otherwise noted, the term “group” means one or more (i.e. at least one).

Embodiments of the present invention provide light sources, having SPDs S(λ) composed of SPDs of n coloured components Sᵢ(λ). For both composite and component SPDs normalized in power,

$$S ( λ ) = {\sum }_{i = 1}^{n} {c}_{i} {S}_{i} ( λ ) , \qquad ( 2 )$$

where cᵢ are the RPRFs of the components.
The RPRFs of the components can be found from the three equations that follow from the principle of additive colour mixing [G. Wyszecki and W. S. Stiles, Color Science: Concepts and Methods, Quantitative Data and Formulae. Wiley, New York, 2000]:

$$\{ \begin{matrix}{\sum }_{i = 1}^{n} {c}_{i} {X}_{i} = {x}_{T} {\sum }_{i = 1}^{n} {c}_{i} ( {X}_{i} + {Y}_{i} + {Z}_{i} ) , \\ {\sum }_{i = 1}^{n} {c}_{i} {Y}_{i} = {y}_{T} {\sum }_{i = 1}^{n} {c}_{i} ( {X}_{i} + {Y}_{i} + {Z}_{i} ) , \\ {\sum }_{i = 1}^{n} {c}_{i} = 1 ,\end{matrix} \qquad ( 3 )$$

where x_{T} and y_{T} are the CIE 1931 chromaticity coordinates of the composite source and Xᵢ, Yᵢ, and Zᵢ are the tristimulus values of the normalized SPD of the i-th coloured component.

Embodiments of the present invention provide sources of white light, having chromaticities that are nearly identical to those of blackbody or daylight-phase illuminants. In order to characterize and compare different sources of white light in colour saturating ability, aspects of the invention introduce two different colour saturating characteristics of a light source related to the saturation distortions of surface colours of illuminated test colour samples.

To characterize the colour saturating ability of white light, embodiments of the present invention provide an advanced procedure for the assessment colour-rendition properties. A common approach for the assessment of the colour-rendition characteristics of a light source is based on the estimation of colour differences (e.g. shifts of the colour coordinates in an appropriate colour space) for test samples when the source under consideration is replaced by a reference source (e.g. blackbody or extrapolated daylight-phase illuminant). The standard CIE 1995 procedure, which initially was developed for the rating of halophosphate fluorescent lamps with relatively wide spectral bands, and which was later refined and extended, employs only eight to fourteen test samples from the vast palette of colours originated by the artist A. H. Munsell in 1905. When applied to sources composed of narrow-band emitters, such as LEDs, the CIE 1995 procedure receives criticism that is first due to the small number of test samples (eight to fourteen) employed. Other drawbacks are the use of colour shifts in the colour space, which lacks uniformity in terms of perceived colour differences, and the disregard of the shift directions, i.e. only colour fidelity is estimated. An improved approach, the Colour Quality Scale mitigates the latter drawbacks by using a more uniform colour space and negating the components of the shifts that represent increased colour saturation of the samples or using Colour Preference Scale and Gamut Area Scale. However the number of test colour samples (15) used in the CQS is too small to clearly distinguish between sources that render colours with high fidelity and increased/decreased chromatic saturation, because the output of such a rating depends on the set of samples used.

Aspects of the present invention are based on using a larger (and, typically. much larger) number of test samples and on several types of chromatic saturation differences distinguished by human vision for each of these samples. To this end, the entire Munsell palette is employed, which specifies the perceived colours in three dimensions: hue; chroma (saturation); and value (lightness). The Joensuu Spectral Database, available from the University of Joensuu Colour Group (http://spectral.joensuu.fi/), is an example of a spectrophotometrically calibrated set of 1269 Munsell samples that can be used in the practice of an embodiment of the present invention.

Embodiments of the present invention avoid the use of colour spaces, which lack uniformity, in estimating the perceived colour differences (the CIELAB colour space used below for illustrating examples does not affect results). Instead, the differences are evaluated using MacAdam ellipses, which are the experimentally determined regions in the chromaticity diagram (hue-saturation plane), containing colours that are almost indistinguishable by human vision. A nonlinear interpolation of the ellipses determined by MacAdam for 25 colours is employed to obtain the ellipses for the entire 1269-element Munsell palette. For instance, using the inverse distance weighted (geodesic) method, an ellipse centred at the chromaticity coordinates (x, y) has an interpolated parameter (a minor or major semiaxis or an inclination angle) given by [A. Zukauskas et al., IEEE J. Sel. Top. Quantum Electron. 15, 1753]

$$P ( x , y ) = {\sum }_{i = 1}^{25} {h}_{i}^{- 2} {P}_{0} ( {x}_{0 i} , {y}_{0 i} ) / {\sum }_{i = 1}^{25} {h}_{i}^{- 2} , \qquad ( 4 )$$

where P₀(x₀ᵢ, y₀ᵢ) is a corresponding experimental parameter, and hᵢ is the distance from the centre of the interpolated ellipse to an original MacAdam ellipse

hᵢ=\sqrt{(x−x₀ᵢ)²+(y−y₀ᵢ)²}. (5)

Since MacAdam ellipses were originally defined for a constant luminance (˜48 cd/m²), in embodiments of the present invention all Munsell samples are treated as having the same luminance irrespectively of their colour lightness.

In embodiments of the present invention, when a reference source is replaced by that under test, a colour of a test colour sample rendered with increased saturation is defined as that with the chromaticity stretched out of the 3-step MacAdam ellipse and with the positive projection of the colour-shift vector on the saturation direction larger than the size of the ellipse, whereas a colour of a test colour sample rendered with decreased saturation is defined as that with the chromaticity stretched out of the 3-step MacAdam ellipse and with the negative projection of the colour-shift vector on the saturation direction larger than the size of the ellipse. Also, a colour of a test colour sample rendered with high fidelity is defined as that with chromaticity shifted only within the 3-step MacAdam ellipse (i.e. by less than three radii of the ellipse). In all cases, if the chromaticity of a light source does not exactly match the chromaticity of a blackbody or a daylight-phase illuminant, chromatic adaptation is to be taken into account (e.g. in the way used in CIE Publication No. 13.3, 1995 or by W. Davis and Y. Ohno, Opt. Eng. 49, 033602, 2010). As the colour saturating ability for the overall assessment of a light source, embodiments of the present invention use two figures of merit that measure the relative number (percentage) of the test colour samples with colours rendered with increased chromatic saturation (Colour Saturation Index, CSI) and the relative number (percentage) of the test colour samples with colours rendered with decreased chromatic saturation (Colour Dulling Index, CDI). These two figures of merit, which are measured in percents in respect of the total number of the test Munsell samples (1269), are the proposed alternatives to the Colour Preference Scale and Gamut Area Scale of CQS based on 15 test samples, and other gamut area indices based on 4 to 15 test samples. Since CSI and CDI are presented in the same format (statistical percentage of the same set of test colour samples) they are easy to analyze and compare. Also, embodiments of the present invention utilize a supplementary figure of merit that measures the relative number (percentage) of the test colour samples with colours rendered with high fidelity (Colour Fidelity Index, CFI).

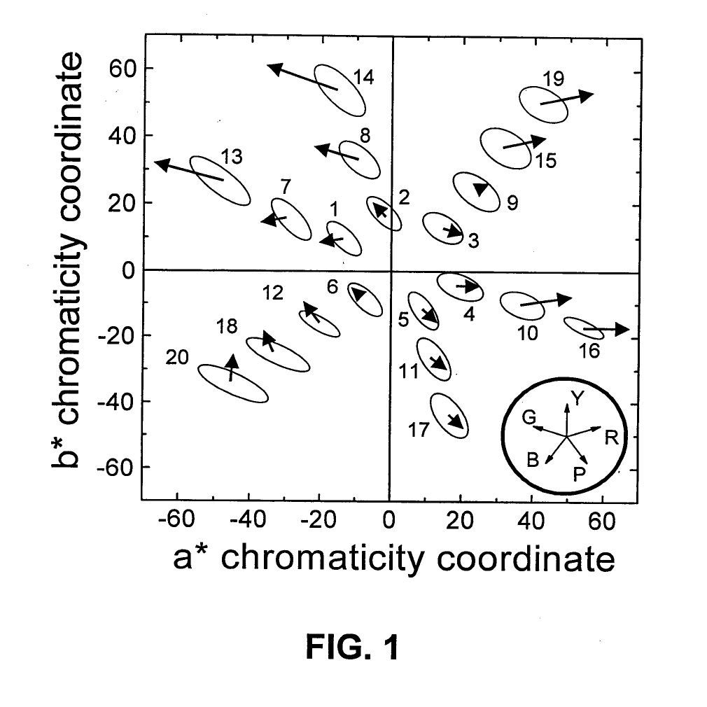

FIG. 1 illustrates the method of the assessment of colour rendition characteristics used in embodiments of the present invention. For simplicity, 20 3-step MacAdam ellipses are shown. The ellipses are displayed within the a*-b* chromaticity plane of the CIELAB colour space, where the white point resides at the centre of the diagram. Colour saturation (chroma) of a sample is represented by the distance of a colour point from the centre of the diagram, whereas hue is represented by the azimuth position of the point. The arrows in FIG. 1 are the chromaticity shift vectors, which have the initial points at the centres of the ellipses, i.e. at the chromaticities of the samples illuminated by a reference source, and the senses of the vectors are at the chromaticities of the samples illuminated by a source under assessment. The insert shows the five hue directions that are close to the principle Munsell directions (red, yellow, green, blue, and purple). Within this illustration, seven different samples of 20 (8, 10, 13, 14, 15, 16, and 19) are rendered with increased saturation (CSI=35) and three different samples of 20 (12, 18, and 20) are rendered with decreased saturation (CDI=15). The rest ten samples are rendered either with high fidelity (2, 3, 4, 5, 6, 9, 11, and 17; CFI=40) or have only distorted hue (1 and 7).

Embodiments of the present invention relate to polychromatic sources of white light, having CCTs within at least the entire standard range of 2700 K to 6500 K, and which are composed of n groups of coloured components (n≧2), such as LEDs, having different SPDs. Such sources are optimized through the selection of the most appropriate SPDs and RPRFs of each group of coloured emitters in such a way that the colour saturating ability of white light with a predetermined CCT could be established and controlled by setting a desired ratio of CSI and CDI.

A first aspect of the invention provides a light source, having a predetermined CCT, comprising at least two groups of visible-light emitters, the SPDs and RPRFs generated by each group of emitters being established such that in comparison with a reference light source, when each of more than fifteen test colour samples resolved by an average human eye as different is illuminated, the colour saturating ability of illumination is established in such a way that: (a) colours of at least of a predetermined fraction of the test colour samples are rendered with increased chromatic saturation and colours of at most of another predetermined fraction of the test colour samples are rendered with decreased chromatic saturation; or (b) colours of at least of a predetermined fraction of the test colour samples are rendered with decreased chromatic saturation and colours of at most of another predetermined fraction of the test colour samples are rendered with increased chromatic saturation; or (c) colours of at most of a predetermined fraction of the test colour samples are rendered with decreased chromatic saturation and colours of at most of another predetermined fraction of the test colour samples are rendered with increased chromatic saturation. Since high CSI values result in shifting of the red and blue components to the edges of the visible spectrum and in a drop of the net LER to marginal values (A. Zukauskas et al. Opt. Expr. 18, 2287, 2010), sources optimized according the first aspect of the invention must preferably have a predetermined lowest possible net LER or lowest possible luminous efficiency.

Light sources provided by the first aspect of the invention may contain groups of coloured emitters having various profiles of SPDs. For specificity, the searched SPDs of coloured emitters can be approximated by, e.g. Gaussian lines with a full width at half magnitude of the electroluminescence bands of 30 nm (which is an average value for common high-brightness AlInGaP and InGaN LEDs at typical operating junction temperatures). Within such an approach, herein the optimal peak positions of the SPDs and RPRFs are selected. Alternatively, light sources provided by the first aspect of the invention may contain coloured emitters with predetermined profiles of SPDs each characterized by an individual peak position and band width. Within such an approach, herein only the optimal RPRFs are selected.

A second aspect of the invention provides a light source, having a predetermined CCT, comprising at least two groups of visible-light emitters having predetermined SPDs of any profile with the RPRFs generated by each group of emitters being synchronously varied in such a way that in comparison with a reference light source, when each of more than fifteen test colour samples resolved by an average human eye as different is illuminated, (a) the fraction of the test colour samples that are rendered with increased saturation, increases, while the fraction of the test colour samples that are rendered with decreased saturation decreases; or (b) the fraction of the test colour samples that are rendered with increased saturation, decreases, while the fraction of the test colour samples that are rendered with decreased saturation increases.

Light sources provided by the second aspect of the invention contain coloured emitters with predetermined profiles of SPDs each characterized by an individual peak position and band width. Within such an approach, herein only the optimal RPRFs are selected.

In embodiments of the present invention, the selection of the most appropriate SPDs and RPRFs is based on three common colour mixing equations. An SPD composed of n coloured components is characterized by a vector in the 2n-dimensional parametric space of peak wavelengths and RPRFs that are subjected to three constraints that follow from the three colour-mixing equations. Within the first aspect of the invention, when both the optimal peak positions of the SPDs and RPRFs are selected, the optimization domain, where an objective function is maximized, is the parametric space with 2n−3 degrees of freedom. For instance, for n=3 the optimization problem can be solved by searching inside the 3-dimensional parametric space of, e.g. three peak wavelengths (the three RPRFs are found from the three colour-mixing equations). Alternatively, when the optimal peak positions of the SPDs are known and only RPRFs are selected, the optimization domain, where an objective function is maximized, is the parametric space with n−3 degrees of freedom. For instance, for n=3 the parametric space is 0-dimensional, i.e. the three peak wavelengths can be found directly from the colour-mixing equations. Within the second aspect of the invention, the optimization domain is the parametric space with n−3 degrees of freedom. For instance, for n=4 the optimization problem can be solved by searching inside the 1-dimensional parametric space of, e.g. one RPRF (the rest three RPRFs are found from the three colour-mixing equations). The objective function maximized in the optimization process herein is a combination of CSI and CDI. The optimization process can also be subjected to constraints that preset minimal possible values of LER or luminous efficiency. A computer routine, which performs searching on a multi-dimensional surface, can be used for finding the maximal value of the objective function. For a large number of dimensions, heuristic approaches that increase the operating speed of the searching routine can be applied.

The optimized SPDs provided by the aspects of the invention are represented by peak wavelengths and RPRFs of the coloured components and characterized by the two colour saturating characteristics (CSI and CDI) and LER. All simulated SPDs have the chromaticity point exactly on the CIE daylight locus or blackbody locus in order to avoid chromatic adaptation problems. The maximization of either CSI or CDI, or maximization of the difference of those, or the minimization of the both indices provide SPDs of sources of white light with a predetermined colour saturating ability that cannot be attained within other approaches based on the general colour rendering index, colour quality scale, or gamut area. Another advantage of light sources provided by embodiments of the present invention is the possibility of dynamical tailoring of colour saturating ability, i.e. adaptation of the source to the individual needs of a user in colour quality of illumination.

In embodiments of the present invention, the optimized SPDs of polychromatic solid-state lamps within the first aspect of the invention can be obtained for various restrictions for CSI and CDI. For the 30-nm wide Gaussian coloured components, in the CCT range from 2700 K to 6500 K and with LER is preset to a minimal value of 250 lm/W, the restrictions for CSI and CDI can be obtained for the LED clusters as follows:

The restriction of CDI to at most of 5% and CSI to at least of 50%, respectively can be attained for a tree-component cluster comprising LEDs with the peak wavelengths selected from the ranges of 405-490 nm, 505-560 nm, and 600-642 nm, respectively. High CSI values and low CDI values require the absence of emission in the yellow region between 560 nm and 600 nm.
The restriction of CSI to at most of 5% and CDI to at least 50%, respectively, can be attained for a two-component cluster comprising an LED with the peak wavelength selected from the range of 568-585 and another LED with the peak wavelength, which is complementary to that of the first LED in such a way that the desirable white chromaticity point is maintained (405-486 nm). The same restriction can be attained for a three-component cluster comprising LEDs with the peak wavelengths selected from the ranges of 405-486 nm, 560-600 nm, and the third LED with the peak wavelength, which complements the first and second LEDs in such a way that the desirable white chromaticity point is maintained (400-700 nm). High CDI values and low CSI values require low emission in the red region above 600 nm.
The restriction of both CSI and CDI to at most 16% can be attained for a tree-component cluster comprising LEDs with the peak wavelengths selected from the ranges of 410-489 nm, 515-566 nm, and 595-644 nm, respectively. CDI and CSI can be restricted to even a lower value of 3% for a four component cluster comprising LEDs with the peak wavelengths selected from the ranges of 419-478 nm, 490-540 nm, 550-592 nm, and 612-660 nm, respectively. Both low CSI and low CDI values require the presence of substantial emission in both red and yellow regions.

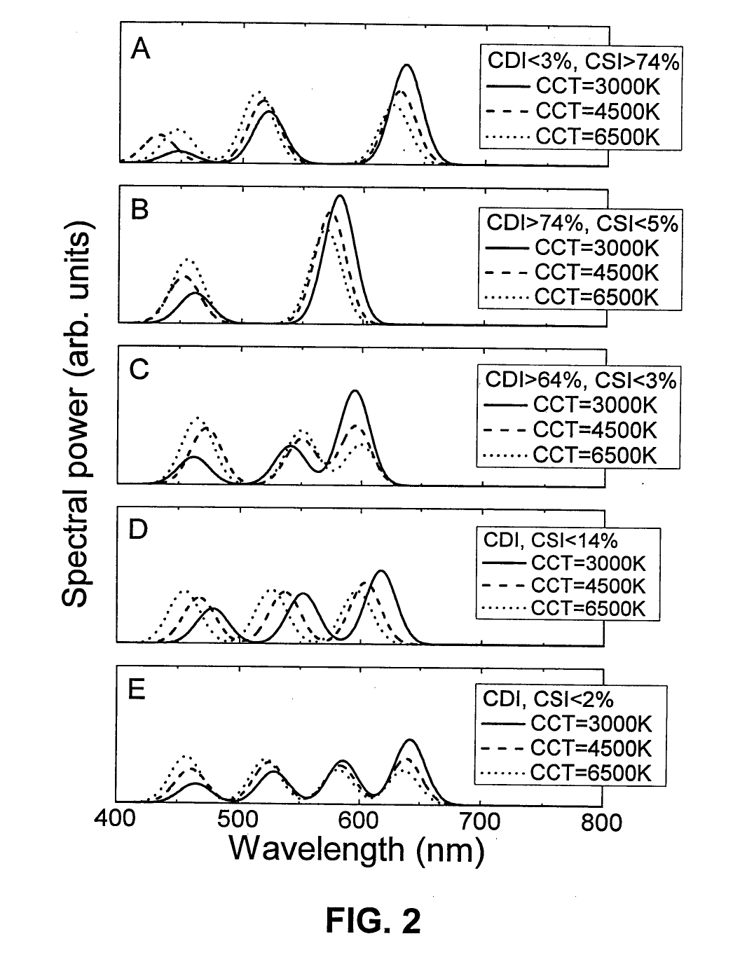

FIG. 2 depicts examples of the optimized SPDs of polychromatic solid-state lamps obtained within the first aspect of the invention, when both peak positions and RPRFs of the 30-nm wide coloured components were established within the optimization process. The optimization results are shown for three standard values of CCT (3000 K, solid lines; 4500 K, dashed lines; and 6500 K, dotted lines).

The first mode of carrying out the first aspect of the present invention is a light source with the maximized colour saturating ability with CCT predetermined in the range from 2700 K to 6500 K and minimal LER predetermined in the range from 250 lm/W to 260 lm/W may comprise three groups of coloured light-emitting diodes, with the peak wavelengths of around 408-486 nm, 509-553 nm, and 605-642 nm; the number of different test colour samples within the set can be larger than 1000; the minimal fraction of the test colour samples that are rendered with increased chromatic saturation can be predetermined in excess of 60%; the maximal fraction of the test colour samples that are rendered with decreased chromatic saturation can be predetermined below 4%.

More specifically, the white light source, having LER of at least 250 lm/W, may comprise, for example, three groups of LEDs, having average band width of about 30 nm. For 1200 different test colour samples, such a source can render:

A fraction of test colour samples of at least 75% with increased chromatic saturation and a fraction of test colour samples of at most 2% with decreased chromatic saturation:

(A1) when the peak wavelengths and RPRFs of the LEDs are established around 449 nm, 521 nm, and 635 nm and about 0.069, 0.316, and 0.615, respectively, for a CCT of 3000 K (solid line in FIG. 2, part A);

(A2) when the peak wavelengths and RPRFs of the LEDs are established around 432 nm, 517 nm, and 630 nm and about 0.170, 0.382, and 0.448, respectively, for a CCT of 4500 K (dashed line in FIG. 2, part A);

(A3) when the peak wavelengths and RPRFs of the LEDs are established around 447 nm, 512 nm, and 625 nm and about 0.201, 0.436, and 0.363, respectively, for a CCT of 6500 K (dotted line in FIG. 2, part A).

The value of CSI decreases by no more than 5%, when the peak wavelengths differ form the above indicated by about 50 nm, 10 nm, and 20 nm for the first, second, and third components, respectively.

Another mode of carrying out the first aspect of the present invention is a light source with the maximized colour dulling ability with CCT predetermined in the range from 2700 K to 6500 K and minimal LER predetermined in the range from 250 lm/W to 400 lm/W may comprise two groups of coloured LEDs, with the peak wavelengths of around 405-486 nm and 570-585 nm or three groups of coloured LEDs, with the peak wavelengths of around 405-486 nm, 490-560 nm and 585-600 nm; the number of different test colour samples within the set can be larger than 1000; the minimal fraction of the test colour samples that are rendered with decreased chromatic saturation can be predetermined in excess of 60%; the maximal fraction of the test colour samples that are rendered with increased chromatic saturation can be predetermined below 4%.

More specifically, the white light source, having LER of at least 390 lm/W, may comprise, for example, two groups of LEDs, having average band width of about 30 nm. For 1200 different test colour samples, such a source can render:

A fraction of test colour samples of at least 75% with decreased chromatic saturation and a fraction of test colour samples of at most 4% with increased chromatic saturation:

(B1) when the peak wavelengths and RPRFs of the LEDs are established around 462 nm and 579 nm and about 0.189 and 0.811, respectively, for a CCT of 3000 K (solid line in FIG. 2, part B);

(B2) when the peak wavelengths and RPRFs of the LEDs are established around 458 nm and 573 nm and about 0.302 and 0.698, respectively, for a CCT of 4500 K (dashed line in FIG. 2, part B);

(B3) when the peak wavelengths and RPRFs of the LEDs are established around 459 nm and 570 nm and about 0.409 and 0.591, respectively, for a CCT of 6500 K (dotted line in FIG. 2, part B).

The value of CDI decreases by no more than 5%, when the peak wavelengths differ form the above indicated by about 15 nm and 3 nm for the first and second components, respectively.

Alternatively, the white light source, having LER of at least 350 lm/W, may comprise, for example, three groups of LEDs, having average band width of about 30 nm. For 1200 different test colour samples, such a source can render:

A fraction of test colour samples of at least 65% with decreased chromatic saturation and a fraction of test colour samples of at most 2% with increased chromatic saturation:

(C1) when the peak wavelengths and RPRFs of the LEDs are established around 462 nm, 541 nm, and 594 nm and about 0.170, 0.242, and 0.588, respectively, for a CCT of 3000 K (solid line in FIG. 2, part C);

(C2) when the peak wavelengths and RPRFs of the LEDs are established around 472 nm, 550 nm, and 595 nm and about 0.348, 0.284, and 0.368, respectively, for a CCT of 4500 K (dashed line in FIG. 2, part C);

(C3) when the peak wavelengths and RPRFs of the LEDs are established around 465 nm, 550 nm, and 599 nm and about 0.408, 0.338, and 0.254, respectively, for a CCT of 6500 K (dotted line in FIG. 2, part C).

The value of CDI decreases by no more than 5%, when the peak wavelengths differ form the above indicated by about 3 nm, 4 nm, and 3 nm for the first, second, and third components, respectively.

The third mode of carrying out the first aspect of the present invention is a light source with low chromatic saturation distortions with CCT predetermined in the range from 2700 K to 6500 K and minimal LER predetermined in the range from 250 lm/W to 400 lm/W may comprise three groups of coloured LEDs, with the peak wavelengths of around 433-487 nm, 519-562 nm, and 595-637 nm of four groups of coloured LEDs, with the peak wavelengths of around 434-475 nm, 495-537 nm, 555-590 nm, and 616-653 nm; the number of different test colour samples within the set can be larger than 1000; the fractions of the test colour samples that are rendered with decreased chromatic saturation and of the test colour samples that are rendered with increased chromatic saturation can be minimized below 14% and below 2% for three and four LEDs, respectively.

More specifically, the white light source, having LER of at least 330 lm/W, may comprise, for example, three groups of LEDs, having average band width of about 30 nm. For 1200 different test colour samples, such a source can render:

The fractions of test colour samples with increased chromatic saturation and of test colour samples with decreased chromatic saturation are minimized below 14%:

(D1) when the peak wavelengths and RPRFs of the LEDs are established around 478 nm, 552 nm, and 617 nm and about 0.217, 0.317, and 0.466, respectively, for a CCT of 3000 K (solid line in FIG. 2, part D);

(D2) when the peak wavelengths and RPRFs of the LEDs are established around 478 nm, 552 nm, and 617 nm and about 0.366, 0.304, and 0.330, respectively, for a CCT of 4500 K (dashed line in FIG. 2, part D);

(D3) when the peak wavelengths and RPRFs of the LEDs are established around 455 nm, 526 nm, and 597 nm and about 0.327, 0.339, and 0.334, respectively, for a CCT of 6500 K (dotted line in FIG. 2, part D).

The values of CSI and CDI increase by no more than 5%, when the peak wavelengths differ form the above indicated by about 2 nm, 1 nm, and 3 nm for the first, second, and third components, respectively.

Alternatively, the white light source, having LER of at least 300 lm/W, may comprise, for example, four groups of LEDs, having average band width of about 30 nm. For 1200 different test colour samples, such a source can render:

The fractions of test colour samples with increased chromatic saturation and of test colour samples with decreased chromatic saturation are minimized below 2%:

(E1) when the peak wavelengths and RPRFs of the LEDs are established around 465 nm, 529 nm, 586 nm, and 642 nm and about 0.121, 0.202, 0.271, and 0.406, respectively, for a CCT of 3000 K (solid line in FIG. 2, part E);

(E2) when the peak wavelengths and RPRFs of the LEDs are established around 461 nm, 525 nm, 584 nm, and 639 nm and about 0.212, 0.259, 0.242, and 0.287, respectively, for a CCT of 4500 K (dashed line in FIG. 2, part E);

(E3) when the peak wavelengths and RPRFs of the LEDs are established around 457 nm, 522 nm, 582 nm, and 637 nm and about 0.291, 0.278, 0.217, and 0.214, respectively, for a CCT of 6500 K (dotted line in FIG. 2, part E).

The values of CSI and CDI increase by no more than 5%, when the peak wavelengths differ form the above indicated by about 6 nm, 3 nm, 3 nm, and 12 nm for the first, second, third, and fourth components, respectively.

Table 1 provides with numerical data of parameters for SPDs displayed in FIG. 2 (CSI, CDI, LER, peak wavelengths, and RPRFs). Values of the general colour rendering index Rₐ and colour fidelity index (CFI) are also presented in Table 1.

Similar optimization data can be obtained for other values of CCT and minimal LER. Lower and higher CCTs result in a relative increase of RPRFs of the longer-wavelength and shorter-wavelength coloured components, respectively. Lower values of minimal LER result in a wider span of the components over the spectrum, especially for sources with high CSI. However, all high-CSI SPDs have low spectral power in the yellow-green region of the spectrum (approximately between 560 nm and 600 nm); all high-CDI SPDs have low spectral power in the red region of the spectrum (below 600 nm); and all SPDs with both low CSI and CDI have substantial spectral power both in the red and yellow regions of the spectrum.

TABLE 1

| CCT | | | LER | | | Peak wavelengths (nm) | | | | Relative partial radiant fluxes | | | |
|---|---|---|---|---|---|---|---|---|---|---|---|---|---|
| (K) | CSI | CDI | (lm/W) | Rₐ | CFI | LED 1 | LED 2 | LED 3 | LED 4 | LED 1 | LED 2 | LED 3 | LED 4 |
| 3000 | 82 | 1 | 250 | −3 | 5 | 449 | 521 | — | 635 | 0.069 | 0.316 | — | 0.615 |
| 4500 | 79 | 1 | 253 | 11 | 5 | 432 | 517 | — | 630 | 0.170 | 0.382 | — | 0.448 |
| 6500 | 78 | 2 | 252 | 16 | 3 | 447 | 512 | — | 625 | 0.201 | 0.436 | — | 0.363 |
| 3000 | 1 | 81 | 480 | −9 | 4 | 462 | — | 579 | — | 0.189 | — | 0.811 | — |
| 4500 | 4 | 78 | 443 | 1 | 3 | 458 | — | 573 | — | 0.302 | — | 0.698 | — |
| 6500 | 4 | 77 | 392 | 12 | 3 | 459 | — | 570 | — | 0.409 | — | 0.591 | — |
| 3000 | 1 | 67 | 442 | 45 | 16 | 462 | 541 | 594 | — | 0.170 | 0.242 | 0.588 | — |
| 4500 | 1 | 65 | 386 | 51 | 16 | 472 | 550 | 595 | — | 0.348 | 0.284 | 0.368 | — |
| 6500 | 1 | 65 | 356 | 60 | 13 | 465 | 550 | 599 | — | 0.408 | 0.338 | 0.254 | — |
| 3000 | 10 | 10 | 365 | 88 | 60 | 478 | — | 552 | 617 | 0.217 | — | 0.317 | 0.466 |
| 4500 | 10 | 13 | 332 | 85 | 51 | 478 | — | 552 | 617 | 0.366 | — | 0.304 | 0.330 |
| 6500 | 12 | 12 | 341 | 85 | 52 | 455 | — | 526 | 597 | 0.327 | — | 0.339 | 334 |
| 3000 | 0 | 1 | 313 | 97 | 94 | 465 | 529 | 586 | 642 | 0.121 | 0.202 | 0.271 | 0.406 |
| 4500 | 1 | 1 | 317 | 97 | 90 | 461 | 525 | 584 | 639 | 0.212 | 0.259 | 0.242 | 0.287 |
| 6500 | 1 | 1 | 301 | 96 | 86 | 457 | 522 | 582 | 637 | 0.291 | 0.278 | 0.217 | 0.214 |

FIG. 2 and Table 1 show that optimized polychromatic sources with the predetermined colour saturating characteristics have many common features such as:

(A) The two colour saturating characteristics are in a negative trade-off, i.e. sources, having increased CDI, have decreased CSI and vice versa;

(B) In sources with high values of CSI, the spectral power in the range between 560 nm and 600 nm is low;

(C) In sources with high values of CDI, the spectral power in the range below 600 nm is low;

(D) In sources with low values of both CDI and CSI, the spectral power in both the ranges above 600 nm and between 560 nm and 600 nm is substantial;

(E) Sources with higher CSI have lower LER as compared to sources with higher CDI, since the former ones have low spectral power in the range between 560 nm and 600 nm, where spectral LER is high.

From data such as that depicted in FIG. 2 and Table 1, and other data similarly obtained in accordance with the teachings of the first aspect of the present invention, a polychromatic light source, having a predetermined CCT and a predetermined lowest LER or lowest luminous efficiency, can be composed of at least three groups of different coloured emitters, the SPDs and RPRFs generated by each group of emitters being optimally established such that when a set of test colour samples resolved by an average human eye as different is illuminated, the number of samples rendered with increased chromatic saturation can have values of at least of predetermined ones, while the number of samples rendered with decreased chromatic saturation can have values of at most of predetermined ones. Alternatively, a polychromatic light source, having a predetermined CCT and a predetermined lowest LER or lowest luminous efficiency, can be composed of at least two groups of different coloured emitters, the SPDs and RPRFs generated by each group of emitters being optimally established such that when a set of test colour samples resolved by an average human eye as different is illuminated, the number of samples rendered with decreased chromatic saturation can have values of at least of predetermined ones, while the number of samples rendered with increased chromatic saturation can have values of at most of predetermined ones. The third option is a polychromatic light source, having a predetermined CCT and a predetermined lowest LER or lowest luminous efficiency, composed of at least three groups of different coloured emitters, the SPDs and RPRFs generated by each group of emitters being optimally established such that when a set of test colour samples resolved by an average human eye as different is illuminated, both the number of samples rendered with decreased chromatic saturation and the number of samples rendered with increased chromatic saturation can have values at most of predetermined ones.

The optimization can involve such features as, for instance,

(A) maximizing the number of test colour samples that are rendered with increased chromatic saturation, when the number of samples that are rendered with decreased chromatic saturation is limited to a value that is smaller that the maximal allowed one;

(B) maximizing the number of test colour samples that are rendered with decreased chromatic saturation, when the number of samples that are rendered with increased chromatic saturation is limited to a value that is smaller that the maximal allowed one.

(C) maximizing the difference of the number of test colour samples that are rendered with increased chromatic saturation and the number of samples that are rendered with decreased chromatic saturation;

(D) maximizing the difference of the number of test colour samples that are rendered with decreased chromatic saturation and the number of samples that are rendered with increased chromatic saturation;

(E) minimizing both the number of test colour samples that are rendered with increased chromatic saturation and the number of test colour samples that are rendered with decreased chromatic saturation.

The number of test colour samples within the set is preferably higher than 15 and samples with very different hue, chroma, and value can be utilized.

Within the first aspect of the invention, the optimized SPDs of polychromatic solid-state lamps with various restrictions for CSI and CD can be also obtained for coloured components with predetermined profiles of SPDs each characterized by an individual peak position and band width. Such colour components can be generated by commercially available direct-emission LEDs. Provided that LEDs with appropriate peak wavelengths are available, only the optimal RPRFs of such LEDs are selected.

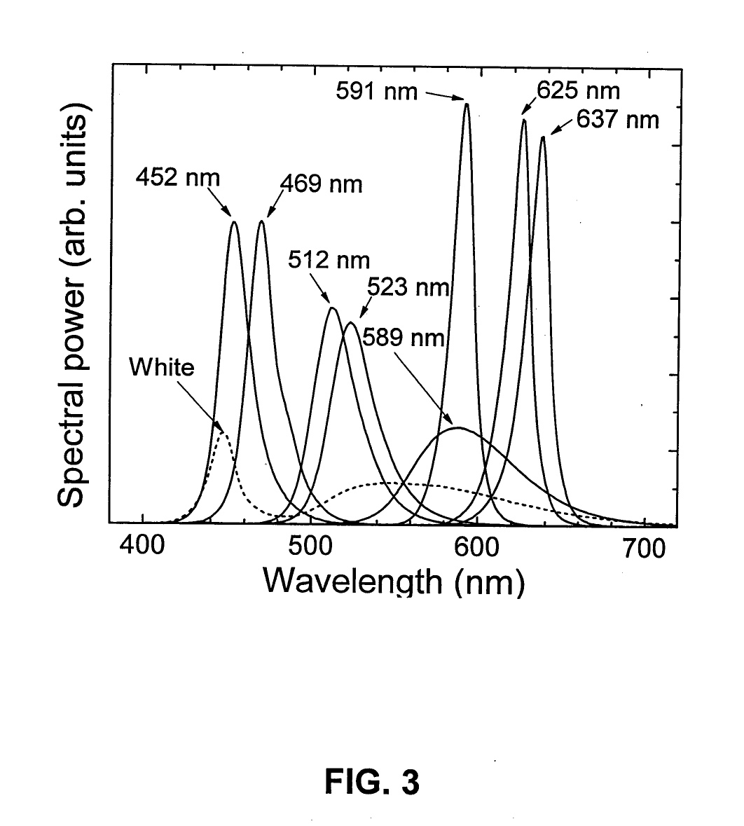

FIG. 3 shows SPDs of nine types of actual LEDs considered in the optimization of practical polychromatic light sources within the first aspect of the invention (the SPDs are normalized in power). Eight SPDs presented by the solid lines are typical of mass-produced commercial coloured LEDs that are available only for certain peak wavelengths that meet the needs of display and signage industries. The profile of the SPDs is seen to be somewhat different from the Gaussian and feature asymmetry; also LEDs of different colours have different band widths. Herein we designate these LEDs by their peak positions and colours. The blue 452-nm and 469-nm InGaN LEDs (band widths of about 20 nm) are used in full-colour video displays. The cyan 512-nm and green 523-nm InGaN LEDs (band widths of about 30 nm and 32 nm, respectively) are used in traffic lights and video displays, respectively. The amber 591-nm AlGaInP LED (band width of about 15 nm) and InGaN phosphor converted 589-nm LED (band width of about 70 nm) are used in traffic lights and automotive signage. The red 625-nm and 637-nm AlGaInP LEDs (band widths of about 15 nm and 16 nm, respectively) are used in video displays and traffic lights, respectively, as well as in many kinds of signage. The ninth SPD presented by the dashed line is typical of a dichromatic white phosphor conversion LED having two spectral peaks at about 447 nm and 547 nm with the band widths of about 18 nm and 120 nm, respectively. Such LEDs are used in general lighting applications and signage.

According to the first aspect of the invention, for a polychromatic source of white light with high CSI and low CDI, three coloured emitters are to be selected from either 452-nm or 469-nm LEDs; either 512-nm or 523-nm LEDs; and either 625-nm or 637-nm LEDs. For a polychromatic source of white light with high CDI and low CSI, no appropriate LEDs are available for a two-component cluster that has the required white chromaticity. However, such a source can be composed of three coloured emitters, which are to be selected from either 452-nm or 469-nm LEDs; either 512-nm or 523-nm LEDs; and either 589-nm or 591-nm LEDs. A polychromatic light source with both CSI and CDI low can be composed of three LEDs only for CCT higher than 4500 K. One LED is to be selected from either 452-nm or 469-nm LEDs and the rest two are 512-nm and 589-nm LEDs. Also, such a source can be composed of four coloured emitters, which are to be selected from either 452-nm or 469-nm LEDs; either 512-nm or 523-nm LEDs; either 589-nm or 591-nm LEDs; and either 625-nm or 637-nm LEDs.

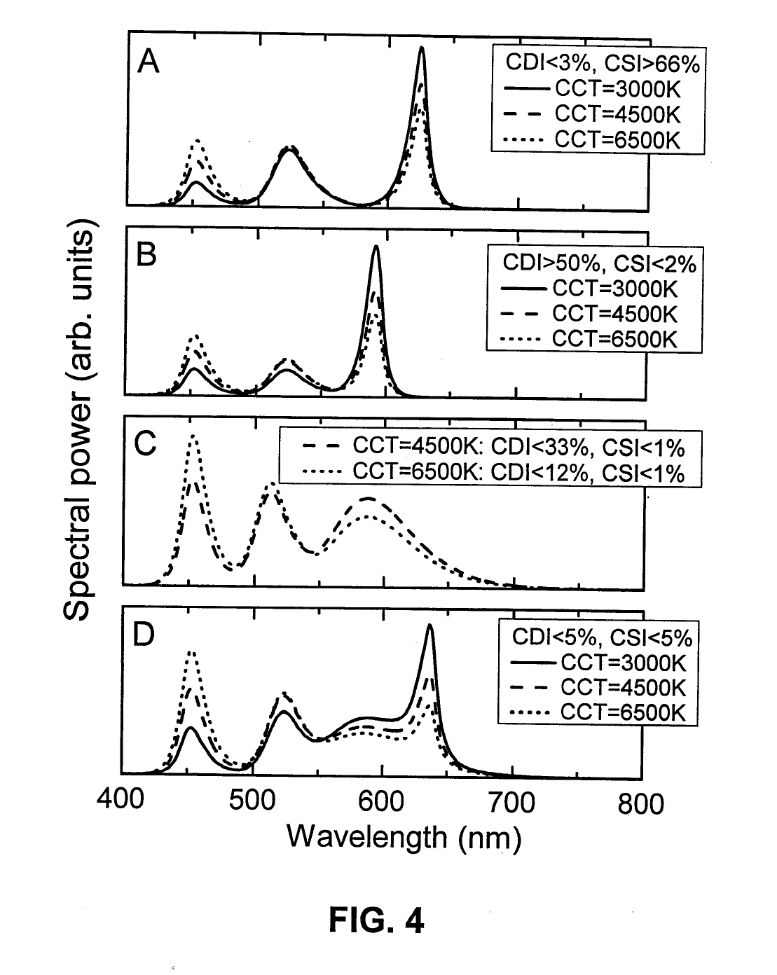

FIG. 4 depicts examples of the optimized SPDs of polychromatic solid-state lamps obtained within the first aspect of the invention, when the RPRF of each LED with the predetermined profile of SPD was established within the optimization process. The optimization results are shown for three standard values of CCT (3000 K, solid lines; 4500 K, dashed lines; and 6500 K, dotted lines).

The first example is a light source with the maximized colour saturating ability and minimized colour dulling ability, which comprises three groups of LEDs with the selected peak wavelengths of 452 nm, 523 nm, and 625 nm. For 1200 different test colour samples, such a source can render a fraction of test colour samples of at least 65% with increased chromatic saturation and a fraction of test colour samples of at most 3% with decreased chromatic saturation:

(A1) when the RPRFs of the LEDs of about 0.103, 0.370, and 0.527, respectively, are established for a CCT of 3000 K (solid line in FIG. 4, part A);

(A2) when the RPRFs of the LEDs of about 0.195, 0.401, and 0.405, respectively, are established for a CCT of 4500 K (dashed line in FIG. 4, part A);

(A3) when the RPRFs of the LEDs of about 0.283, 0.392, and 0.325, respectively, are established for a CCT of 6500 K (dotted line in FIG. 4, part A).

The second example is a light source with the maximized colour dulling ability and minimized colour saturating ability, which comprises three groups of LEDs with the selected peak wavelengths of 452 nm, 523 nm, and 591 nm. For 1200 different test colour samples, such a source can render a fraction of test colour samples of at least 50% with decreased chromatic saturation and a fraction of test colour samples of at most 2% with increased chromatic saturation:

(B1) when the RPRFs of the LEDs of about 0.154, 0.228, and 0.618, respectively, are established for a CCT of 3000 K (solid line in FIG. 4, part B);

(B2) when the RPRFs of the LEDs of about 0.254, 0.308, and 0.438, respectively, are established for a CCT of 4500 K (dashed line in FIG. 4, part B);

(B3) when the RPRFs of the LEDs of about 0.346, 0.320, and 0.334, respectively, are established for a CCT of 6500 K (dotted line in FIG. 4, part B).

The third example is a light source with both the colour dulling ability and colour saturating ability minimized, which comprises three or four groups of LEDs. For three LEDs with the selected peak wavelengths of 452 nm, 512 nm, and 589 nm, such a source can render the fractions of 1200 test colour samples with both increased and with decreased chromatic saturation of at most:

(C1) 33%, when the RPRFs of the LEDs of about 0.207, 0.254, and 0.539, respectively, are established for a CCT of 4500 K (dashed line in FIG. 4, part C);

(C2) 12% when the RPRFs of the LEDs of about 0.291, 0.280, and 0.429, respectively, are established for a CCT of 6500 K (dotted line in FIG. 4, part C). For four LEDs with the selected peak wavelengths of 452 nm, 523 nm, 589 nm, and 637 nm, such a source can render the fractions of 1200 test colour samples with both increased and with decreased chromatic saturation of at most 5%:

(D1) when the RPRFs of the LEDs of about 0.112, 0.225, 0.421, and 0.242, respectively, are established for a CCT of 3000 K (solid line in FIG. 4, part D);

(D2) when the RPRFs of the LEDs of about 0.208, 0.283, 0.353, and 0.156, respectively, are established for a CCT of 4500 K (dashed line in FIG. 4, part D);

(D3) when the RPRFs of the LEDs of about 0.300, 0.293, 0.305, and 0.102, respectively, are established for a CCT of 6500 K (dotted line in FIG. 4, part D).

Table 2 provides with numerical data of parameters for SPDs displayed in FIG. 4 (CSI, CDI, LER, and RPRFs). Values of the general colour rendering index Rₐ and colour fidelity index (CFI) are also presented in Table 2.

TABLE 2

| CCT | | | | | | Relative partial radiant fluxes of LEDs | | | | | | |
|---|---|---|---|---|---|---|---|---|---|---|---|---|
| (K) | CSI | CDI | K (lm/W) | Rₐ | CFI | 452 nm | 512 nm | 523 nm | 589 nm | 591 nm | 625 nm | 637 nm |
| 3000 | 77 | 1 | 327 | 41 | 11 | 0.103 | — | 0.370 | — | — | 0.527 | — |
| 4500 | 70 | 0 | 317 | 49 | 13 | 0.195 | — | 0.401 | — | — | 0.405 | — |
| 6500 | 67 | 2 | 297 | 54 | 12 | 0.283 | — | 0.392 | — | — | 0.325 | — |
| 3000 | 1 | 67 | 447 | 28 | 12 | 0.154 | — | 0.228 | — | 0.618 | — | — |
| 4500 | 1 | 58 | 399 | 51 | 20 | 0.254 | — | 0.308 | — | 0.438 | — | — |
| 6500 | 0 | 51 | 355 | 64 | 24 | 0.346 | — | 0.320 | — | 0.334 | — | — |
| 4500 | 0 | 32 | 345 | 80 | 49 | 0.207 | 0.254 | — | 0.539 | — | — | — |
| 6500 | 0 | 11 | 314 | 88 | 71 | 0.291 | 0.280 | — | 0.429 | — | — | — |
| 3000 | 2 | 2 | 340 | 94 | 87 | 0.112 | — | 0.225 | 0.421 | — | — | 0.242 |
| 4500 | 3 | 3 | 332 | 93 | 77 | 0.208 | — | 0.283 | 0.353 | — | — | 0.156 |
| 6500 | 4 | 4 | 311 | 93 | 72 | 0.300 | — | 0.293 | 0.305 | — | — | 0.102 |

Similar optimization data can be obtained for other values of CCT. Lower and higher CCTs result in a relative increase of RPRFs of the longer-wavelength and shorter-wavelength coloured components, respectively.

From data such as that depicted in FIG. 4 and Table 2, and other data similarly obtained in accordance with the teachings of the first aspect of the present invention, a polychromatic light source, having a predetermined CCT, can be composed of at least three groups of different coloured LEDs, the peak wavelengths and RPRFs generated by each group of LEDs being optimally established such that when a set of test colour samples resolved by an average human eye as different is illuminated, the number of samples rendered with increased chromatic saturation can have values of at least of predetermined ones, while the number of samples rendered with decreased chromatic saturation can have values of at most of predetermined ones. Alternatively, a polychromatic light source, having a predetermined CCT, can be composed of at least two groups of different coloured LEDs, the peak wavelengths and RPRFs generated by each group of LEDs being optimally established such that when a set of test colour samples resolved by an average human eye as different is illuminated, the number of samples rendered with decreased chromatic saturation can have values of at least of predetermined ones, while the number of samples rendered with increased chromatic saturation can have values of at most of predetermined ones. The third option is a polychromatic light source, having a predetermined CCT, composed of at least four groups of different LEDs, the peak wavelengths and the RPRFs generated by each group of LEDs being optimally established such that when a set of test colour samples resolved by an average human eye as different is illuminated, both the number of samples rendered with decreased chromatic saturation and the number of samples rendered with increased chromatic saturation can have values at most of predetermined ones.

The number of test colour samples within the set is preferably higher or even much higher than 15 and samples with very different hue, chroma, and value can be utilized.

Within the second aspect of the invention, SPDs of polychromatic solid-state light sources with dynamically tailored colour saturating ability are composed by varying the RPRFs of the coloured emitters, having already predetermined SPDs. A single set of coloured emitters, such as LED groups, can be optimally selected and used. Embodiments of the present invention can be based on a dynamical tailoring of colour saturating ability by selecting an end-point SPD with a high CDI and low CSI and gradually decreasing the preset value of CDI and maximizing CSI by varying RPRFs of the coloured emitters (e.g. by the variation of the average driving currents for each group of LEDs) until another end-point SPD with a low CDI and high CSI is attained. More specifically, the tailoring of the colour saturating ability can be performed using an SPD, which is a weighted sum of the two end-point SPDs having a high CSI (low CDI) and a high CDI (low CSI), respectively. In particular, the weighted sum of two SPDs that have the highest CSI and the highest CDI available within the selected set of LEDs can be used:

S_{σ}(λ)=σS_{max CSI}(λ)+(1−σ)S_{max CDI}(λ), (6)

where σ is the weight parameter of the trade-off. Such an approach implies that the RPRF of an i-th coloured emitter of the tailored source is the weighted sum of the corresponding RPRFs of the end-point SPDs with the same weight parameter:

Φ_{iσ}=σΦ_{i max CSI}+(1−σ)Φ_{i max CDI}. (7)

In embodiments of the present invention, the tailored light source with CCT varied from 2700 K to 6500 K and LER varying of at least of 250 lm/W may have an SPD composed of at least four 30-nm wide components, with the peak wavelengths of around 405-490 nm, 505-560 nm, 560-600 nm, and 600-642 nm; the number of different test colour samples within the set can be larger than 1000; the fraction of the test colour samples that are rendered with decreased saturation ability can be varied in the range from 1% to 81%; the fraction of the test colour samples that are rendered with increased chromatic saturation can be varied from 0% to 82%. Such a source can also have an SPD composed of components with different band widths.

For example, a polychromatic solid-state lamp with dynamically tailored colour saturating ability can be composed of at least four groups of actual coloured emitters, such as coloured LEDs, having SPDs shown in FIG. 3. In particular, the peak wavelengths of the LEDs can be preselected within or as close as possible to the spectral intervals that were determined in the first aspect of the invention in order to have high values of CSI and CDI at the end points. An alternative approach is to use a phosphor converted LED that has a high colour dulling ability at one end point and a cluster of three coloured LEDs that has a high colour saturating ability at the other end point.

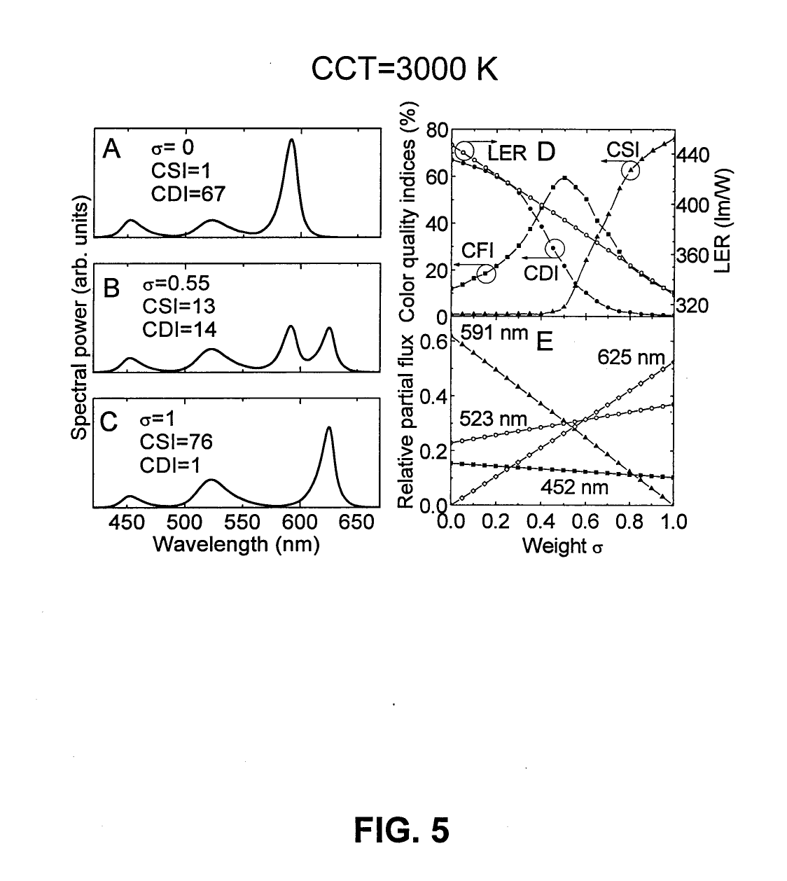

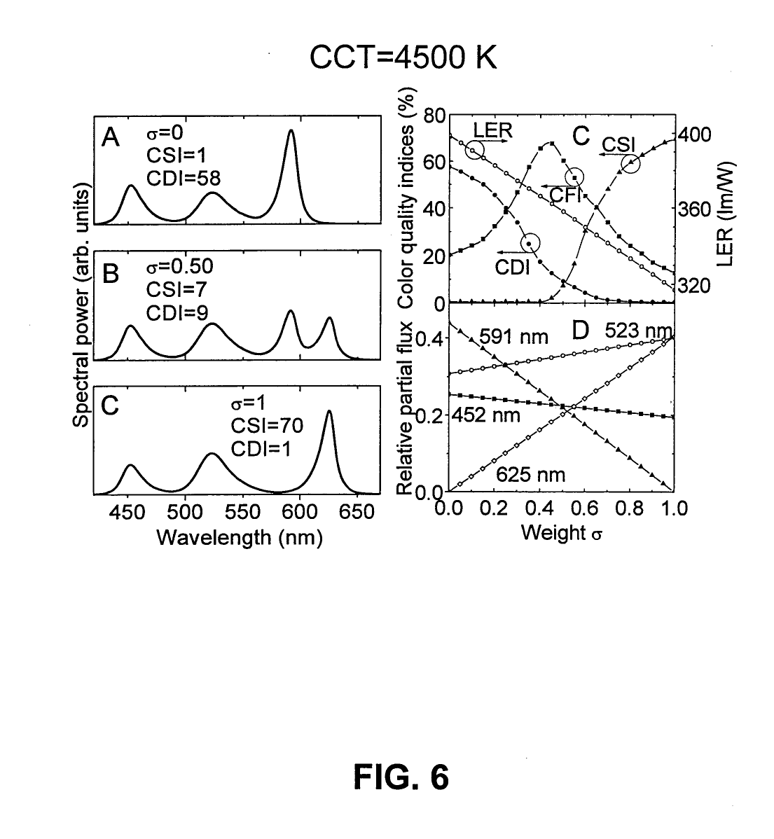

FIGS. 5, 6, and 7 depict the SPDs of polychromatic solid-state lamps with dynamically tailored colour saturating ability for different CCTs obtained within the second aspect of the invention, when the end-point SPDs are composed of the components provided by coloured LEDs. A cluster composed of LEDs with the peak wavelengths of 452-nm, 523-nm, and 625-nm and band widths of 20 nm, 32 nm, and 15 nm, respectively, is used as a colour-saturating end point, whereas as cluster composed of LEDs with the peak wavelengths of 452-nm, 523-nm, and 591-nm and band widths of 20 nm, 32 nm, and 15 nm, respectively, is used as a colour-dulling end point. Since these two end-point clusters have common 452-nm and 523-nm LEDs, tailoring of the colour saturating ability (reducing CDI and increasing CSI) can be performed within a four-LED cluster containing 452-nm, 523-nm, 591-nm, and 625-nm LEDs by the variation of the RPRFs of the LEDs. FIGS. 5, 6, and 7 show the resulting SPDs for the CCTs of 3000 K, 4500 K, and 6500 K, respectively. Parts A of FIGS. 5-7 depict the end-point SPDs for the highest CDI and lowest CSI. Parts B of FIGS. 5-7 depict the weighted SPDs with both CSI and CDI low. Parts C of FIGS. 5-7 depict the end-point SPDs for the highest CSI and lowest CDI. Part D of FIGS. 5-7 show CSI, CDI, and LER as functions of weight parameter σ. Part E of FIGS. 5-7 show the variation of the RPRFs of the four LEDs with σ.

Tables 3, 4, and 5 provide with numerical data for parameters shown in FIGS. 5, 6, and 7, respectively, as well as the values of the general colour rendering index Rₐ and colour fidelity index (CFI).

TABLE 3

| | | | | | | Relative partial radiant fluxes of LEDs | | | |
|---|---|---|---|---|---|---|---|---|---|
| Weight σ | CSI | CDI | K (lm/W) | Rₐ | CFI | 452 nm | 523 nm | 591 nm | 625 nm |
| 0.00 | 1 | 67 | 447 | 28 | 12 | 0.154 | 0.228 | 0.618 | 0.000 |
| 0.05 | 1 | 66 | 441 | 33 | 14 | 0.151 | 0.236 | 0.587 | 0.026 |
| 0.10 | 1 | 64 | 435 | 38 | 16 | 0.149 | 0.243 | 0.556 | 0.053 |
| 0.15 | 1 | 62 | 429 | 44 | 19 | 0.146 | 0.250 | 0.525 | 0.079 |
| 0.20 | 1 | 60 | 423 | 49 | 22 | 0.144 | 0.257 | 0.495 | 0.105 |
| 0.25 | 1 | 57 | 417 | 55 | 26 | 0.141 | 0.264 | 0.464 | 0.131 |
| 0.30 | 1 | 53 | 411 | 60 | 30 | 0.139 | 0.271 | 0.433 | 0.158 |
| 0.35 | 1 | 46 | 405 | 66 | 37 | 0.136 | 0.278 | 0.402 | 0.184 |
| 0.40 | 1 | 39 | 399 | 71 | 47 | 0.134 | 0.285 | 0.371 | 0.210 |
| 0.45 | 2 | 29 | 393 | 76 | 55 | 0.131 | 0.292 | 0.340 | 0.236 |
| 0.50 | 4 | 22 | 387 | 81 | 59 | 0.128 | 0.299 | 0.310 | 0.263 |
| 0.55 | 13 | 14 | 381 | 85 | 55 | 0.126 | 0.306 | 0.279 | 0.289 |
| 0.60 | 24 | 10 | 375 | 86 | 50 | 0.123 | 0.313 | 0.248 | 0.315 |
| 0.65 | 34 | 7 | 369 | 85 | 41 | 0.121 | 0.321 | 0.217 | 0.341 |
| 0.70 | 44 | 4 | 363 | 83 | 35 | 0.118 | 0.328 | 0.186 | 0.368 |
| 0.75 | 55 | 2 | 357 | 80 | 28 | 0.116 | 0.335 | 0.155 | 0.394 |
| 0.80 | 63 | 2 | 351 | 73 | 22 | 0.113 | 0.342 | 0.125 | 0.420 |
| 0.85 | 67 | 1 | 345 | 65 | 18 | 0.111 | 0.349 | 0.094 | 0.446 |
| 0.90 | 71 | 1 | 339 | 57 | 15 | 0.108 | 0.356 | 0.063 | 0.473 |
| 0.95 | 74 | 1 | 333 | 49 | 13 | 0.106 | 0.363 | 0.032 | 0.499 |
| 1.00 | 77 | 1 | 327 | 41 | 11 | 0.103 | 0.370 | 0.000 | 0.527 |

TABLE 4

| | | | | | | Relative partial radiant fluxes of LEDs | | | |
|---|---|---|---|---|---|---|---|---|---|
| Weight σ | CSI | CDI | K (lm/W) | Rₐ | CFI | 452 nm | 523 nm | 591 nm | 625 nm |
| 0.00 | 1 | 58 | 399 | 51 | 20 | 0.254 | 0.308 | 0.438 | 0.000 |
| 0.05 | 1 | 56 | 395 | 55 | 22 | 0.251 | 0.312 | 0.416 | 0.020 |
| 0.10 | 1 | 53 | 391 | 59 | 24 | 0.248 | 0.317 | 0.395 | 0.040 |
| 0.15 | 0 | 50 | 387 | 63 | 27 | 0.245 | 0.322 | 0.373 | 0.061 |
| 0.20 | 0 | 45 | 383 | 68 | 32 | 0.242 | 0.326 | 0.351 | 0.081 |
| 0.25 | 1 | 40 | 379 | 72 | 38 | 0.239 | 0.331 | 0.329 | 0.101 |
| 0.30 | 1 | 34 | 374 | 76 | 47 | 0.236 | 0.336 | 0.307 | 0.121 |
| 0.35 | 1 | 25 | 370 | 81 | 57 | 0.233 | 0.340 | 0.285 | 0.142 |
| 0.40 | 1 | 17 | 366 | 85 | 65 | 0.230 | 0.345 | 0.263 | 0.162 |
| 0.45 | 2 | 13 | 362 | 88 | 68 | 0.227 | 0.350 | 0.241 | 0.182 |
| 0.50 | 7 | 9 | 358 | 90 | 60 | 0.224 | 0.354 | 0.219 | 0.202 |
| 0.55 | 17 | 7 | 354 | 90 | 53 | 0.221 | 0.359 | 0.197 | 0.222 |
| 0.60 | 30 | 4 | 350 | 89 | 45 | 0.218 | 0.363 | 0.175 | 0.243 |
| 0.65 | 40 | 2 | 346 | 87 | 40 | 0.215 | 0.368 | 0.154 | 0.263 |
| 0.70 | 48 | 1 | 342 | 83 | 34 | 0.212 | 0.373 | 0.132 | 0.283 |
| 0.75 | 55 | 1 | 338 | 77 | 28 | 0.209 | 0.377 | 0.110 | 0.303 |
| 0.80 | 60 | 1 | 333 | 72 | 24 | 0.206 | 0.382 | 0.088 | 0.324 |
| 0.85 | 63 | 1 | 329 | 66 | 21 | 0.204 | 0.387 | 0.066 | 0.344 |
| 0.90 | 65 | 0 | 325 | 60 | 17 | 0.201 | 0.391 | 0.044 | 0.364 |
| 0.95 | 68 | 0 | 321 | 55 | 15 | 0.198 | 0.396 | 0.022 | 0.384 |
| 1.00 | 70 | 0 | 317 | 49 | 13 | 0.195 | 0.401 | 0.000 | 0.405 |

TABLE 5

| | | | | | | Relative partial radiant fluxes of LEDs | | | |
|---|---|---|---|---|---|---|---|---|---|
| Weight σ | CSI | CDI | K (lm/W) | Rₐ | CFI | 452 nm | 523 nm | 591 nm | 625 nm |
| 0.00 | 0 | 51 | 355 | 64 | 24 | 0.346 | 0.320 | 0.334 | 0.000 |
| 0.05 | 0 | 47 | 352 | 67 | 26 | 0.343 | 0.323 | 0.317 | 0.016 |
| 0.10 | 0 | 43 | 349 | 71 | 30 | 0.339 | 0.327 | 0.301 | 0.033 |
| 0.15 | 0 | 39 | 346 | 74 | 36 | 0.336 | 0.331 | 0.284 | 0.049 |
| 0.20 | 0 | 34 | 344 | 78 | 42 | 0.333 | 0.334 | 0.267 | 0.065 |
| 0.25 | 0 | 29 | 341 | 81 | 51 | 0.330 | 0.338 | 0.251 | 0.081 |
| 0.30 | 0 | 19 | 338 | 85 | 62 | 0.327 | 0.342 | 0.234 | 0.097 |
| 0.35 | 1 | 14 | 335 | 88 | 67 | 0.324 | 0.345 | 0.217 | 0.114 |
| 0.40 | 3 | 10 | 332 | 90 | 67 | 0.321 | 0.349 | 0.201 | 0.130 |
| 0.45 | 9 | 8 | 329 | 91 | 62 | 0.318 | 0.352 | 0.184 | 0.146 |
| 0.50 | 15 | 6 | 326 | 91 | 54 | 0.314 | 0.356 | 0.167 | 0.162 |
| 0.55 | 26 | 4 | 323 | 91 | 47 | 0.311 | 0.360 | 0.151 | 0.178 |
| 0.60 | 36 | 2 | 320 | 89 | 41 | 0.308 | 0.363 | 0.134 | 0.195 |
| 0.65 | 44 | 2 | 317 | 85 | 34 | 0.305 | 0.367 | 0.117 | 0.211 |
| 0.70 | 50 | 1 | 314 | 81 | 30 | 0.302 | 0.371 | 0.101 | 0.227 |
| 0.75 | 54 | 1 | 311 | 77 | 26 | 0.299 | 0.374 | 0.084 | 0.243 |
| 0.80 | 58 | 1 | 308 | 72 | 22 | 0.296 | 0.378 | 0.067 | 0.259 |
| 0.85 | 61 | 1 | 306 | 68 | 19 | 0.293 | 0.381 | 0.050 | 0.276 |
| 0.90 | 63 | 1 | 303 | 63 | 17 | 0.289 | 0.385 | 0.034 | 0.292 |
| 0.95 | 65 | 1 | 300 | 59 | 14 | 0.286 | 0.389 | 0.017 | 0.308 |
| 1.00 | 67 | 2 | 297 | 54 | 12 | 0.283 | 0.392 | 0.000 | 0.324 |

As seen from data displayed in FIGS. 5, 6, and 7 and Tables 3, 4, and 5, the highest values of CDI and the highest values of CSI are attained for the 3-LED end-point SPDs with σ=0 and σ=1, respectively. These values correspond to the LED clusters optimized within the first aspect of the invention (see FIG. 4 and Table 2). With increasing weight parameter, CDI decreases and CSI increases. At a particular intermediate value of a, both CDI and CSI have almost equal values that are below a certain threshold. For instance, both CDI and CSI do not exceed 14% at σ=0.55 for CCT of 3000 K; 9% at σ=0.50 for CCT of 4500 K; and 9% at σ=0.45 for CCT of 6500 K, respectively. Around these intermediate values of weight parameters, the SPDs have high colour fidelity (high values of CFI).

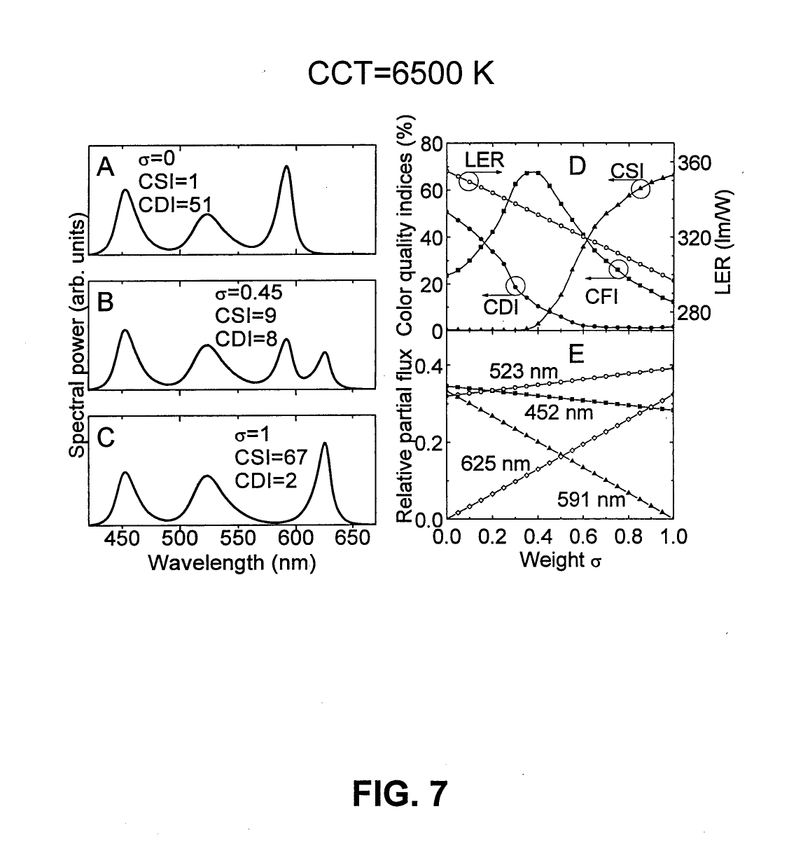

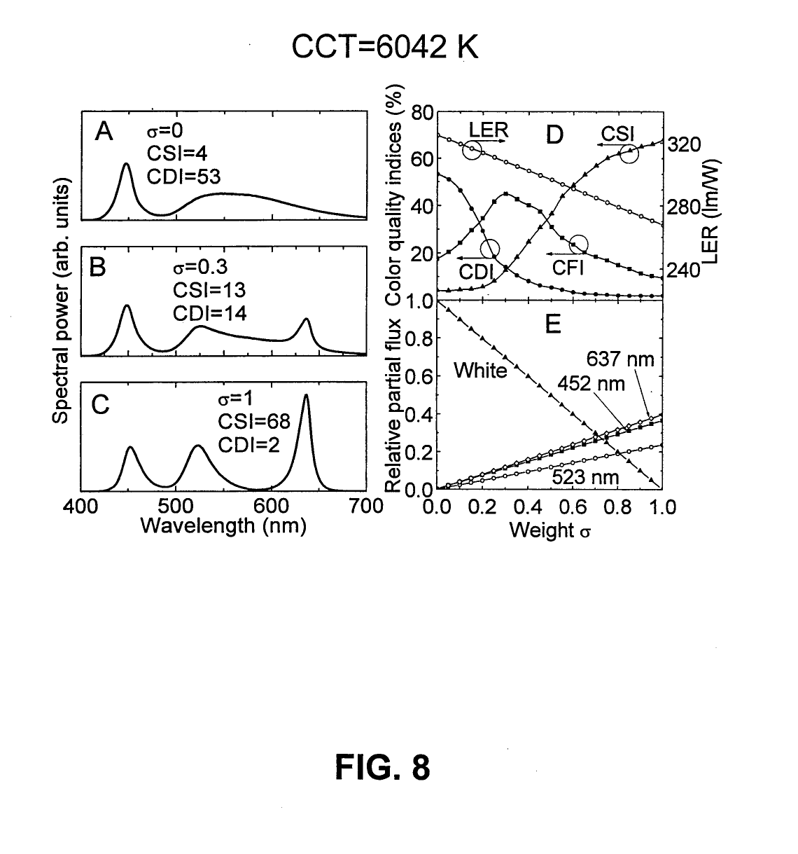

FIG. 8 depict the SPDs of polychromatic solid-state lamps with dynamically tailored colour saturating ability for different CCTs obtained within the second aspect of the invention, when the end-point SPD with the highest CDI is provided by a two-component (blue-yellow) phosphor converted white LED and the end-point SPD with the highest CSI is provided by a coloured-LED cluster composed of 452-nm, 523-nm, and 637-nm LEDs. The lamp has CCT of 6042 K, which is the characteristic of the white LED. Part A of FIG. 8 depicts the end-point SPD for the highest CDI and lowest CSI. Part B of FIG. 8 depicts the weighted SPD with both CDI and CSI low. Part C of FIG. 8 depicts the end-point SPDs for the highest CSI and lowest CDI. Part D of FIG. 8 shows CSI, CDI, and LER as functions of weight parameter σ. Part E of FIG. 8-7 shows the variation of the RPRFs of the four LEDs with σ.

Table 6 provides with numerical data for parameters shown in FIG. 8, as well as the values of the general colour rendering index Rₐ and colour fidelity index (CFI).

TABLE 6

| | | | | | | Relative partial radiant fluxes of LEDs | | | |
|---|---|---|---|---|---|---|---|---|---|
| Weight σ | CSI | CDI | K (lm/W) | Rₐ | CFI | White | 452 nm | 523 nm | 637 nm |
| 0 | 4 | 53 | 325 | 71 | 18 | 1.000 | 0 | 0 | 0 |
| 0.05 | 4 | 51 | 322 | 74 | 20 | 0.947 | 0.021 | 0.012 | 0.021 |
| 0.1 | 4 | 46 | 319 | 77 | 24 | 0.897 | 0.039 | 0.024 | 0.040 |
| 0.15 | 5 | 39 | 316 | 79 | 30 | 0.847 | 0.057 | 0.036 | 0.060 |
| 0.2 | 6 | 29 | 313 | 82 | 35 | 0.797 | 0.075 | 0.047 | 0.080 |
| 0.25 | 8 | 19 | 311 | 83 | 42 | 0.747 | 0.094 | 0.059 | 0.100 |
| 0.3 | 13 | 14 | 308 | 84 | 45 | 0.697 | 0.112 | 0.071 | 0.120 |
| 0.35 | 18 | 11 | 305 | 84 | 43 | 0.648 | 0.130 | 0.083 | 0.140 |
| 0.4 | 25 | 8 | 302 | 82 | 40 | 0.598 | 0.148 | 0.095 | 0.159 |
| 0.45 | 31 | 6 | 299 | 80 | 37 | 0.548 | 0.166 | 0.107 | 0.179 |
| 0.5 | 37 | 5 | 296 | 77 | 31 | 0.498 | 0.184 | 0.119 | 0.199 |
| 0.55 | 44 | 4 | 293 | 75 | 26 | 0.448 | 0.202 | 0.130 | 0.219 |
| 0.6 | 49 | 3 | 291 | 72 | 24 | 0.399 | 0.221 | 0.142 | 0.239 |
| 0.65 | 53 | 3 | 288 | 68 | 20 | 0.349 | 0.239 | 0.154 | 0.258 |
| 0.7 | 57 | 3 | 285 | 64 | 19 | 0.299 | 0.257 | 0.166 | 0.278 |
| 0.75 | 60 | 2 | 282 | 60 | 17 | 0.249 | 0.275 | 0.178 | 0.298 |
| 0.8 | 62 | 2 | 279 | 56 | 15 | 0.199 | 0.293 | 0.190 | 0.318 |
| 0.85 | 63 | 2 | 276 | 51 | 13 | 0.149 | 0.311 | 0.202 | 0.338 |
| 0.9 | 65 | 2 | 273 | 46 | 11 | 0.100 | 0.330 | 0.213 | 0.357 |
| 0.95 | 66 | 2 | 271 | 41 | 10 | 0.050 | 0.348 | 0.225 | 0.377 |
| 1 | 68 | 2 | 268 | 37 | 9 | 0 | 0.366 | 0.237 | 0.397 |

As seen from data displayed in FIG. 8 and Table 6, the highest values of CDI and the highest values of CSI are attained for the end-point SPDs with σ=0 and σ=1, respectively. With increasing weight parameter, CDI decreases and CSI increases. At a particular intermediate value of σ=0.30, both CDI and CSI have almost equal values that are below 14%. At this intermediate value of weight parameter, the SPD has high colour fidelity (high values of CFI).

FIGS. 5 to 8 and Tables 3 to 6 show that polychromatic sources with tailored colour saturating ability have many common features such as:

(A) Continuous variation of weight parameter within the interval from 0 to 1 results in a monotonic decrease of CDI and monotonic increase of CSI.

(B) With increasing weight parameter (i.e. increasing CSI at an expense of CDI), the RPRFs of the red and green components increase, while those of the blue and amber components, as well as LER decrease;

(C) High values of CDI are attained when the red component vanishes;

(D) High values of CSI are attained when the amber (yellow) component vanishes;

(E) Variation of CDI and CSI is nonlinear in respect of weight parameter; the balance between CDI and CSI is attained at σ of about 0.3 to 0.55.

From data such as that depicted in FIGS. 5 to 8 and Tables 3 to 6, and other data similarly obtained in accordance with the teachings of aspects of the present invention, at least four of different LEDs, having predetermined SPDs can composed in to a polychromatic light source, having a predetermined CCT, with colour saturating ability tailored by varying the RPRFs generated by each group of emitters, in such a way that when a set of test colour samples resolved by an average human eye as different is illuminated, the number of samples rendered with decreased chromatic saturation decreases and the number of samples rendered with increased chromatic saturation increases or, alternatively, the number of samples rendered with decreased chromatic saturation increases and the number of samples rendered with increased chromatic saturation decreases. This tailoring can involve such features as, for instance,

(A) maximizing the number of test colour samples that are rendered with increased chromatic saturation;

(B) maximizing the number of test colour samples that are rendered with decreased chromatic saturation;

(C) maximizing the difference of the number of test colour samples that are rendered with increased chromatic saturation and the number of test colour samples that are rendered with decreased chromatic saturation;

(D) maximizing the difference of the number of test colour samples that are rendered with decreased chromatic saturation and the number of test colour samples that are rendered with increased chromatic saturation;

(E) minimizing both the number of test colour samples that are rendered with decreased chromatic saturation and the number of test colour samples that are rendered with increased chromatic saturation;

(F) tailoring colour saturating ability, i.e. ratio of the number of test colour samples that are rendered with decreased chromatic saturation and the number of test colour samples that are rendered with increased chromatic saturation by varying the SPD as a weighted sum of the two end-point SPDs, which are optimized in respect of each of the two numbers, respectively.

The number of test colour samples within the set is preferably higher or even much higher than 15, and samples with very different hue, chroma, and value can be utilized.

More specifically, the white light source may comprise, for example, four groups of LEDs with the peak wavelengths of about 452 nm, 523 nm, 591 nm, and 625 nm and band widths of about 20 nm, 32 nm, 15 nm, and 15 nm, respectively. For 1200 different test colour samples, such a source can be adjusted:

To a highest fraction of test colour samples rendered with decreased chromatic saturation and a lowest fraction of test colour samples rendered with increased chromatic saturation:

(A1) of about 67% and 1%, respectively, for a CCT of 3000 K, by selecting the RPRFs of 0.154, 0.228, 0.618, and 0.000 generated by the 452-nm, 523-nm, 591-nm, and 625-nm LEDs, respectively;

(A2) of about 58% and 1%, respectively, for a CCT of 4500 K, by selecting the RPRFs of 0.254, 0.308, 0.438, and 0.000 generated by the 452-nm, 523-nm, 591-nm, and 625-nm LEDs, respectively;

(A3) of about 51% and 0%, respectively, for a CCT of 6500 K, by selecting the RPRFs of 0.346, 0.320, 0.334, and 0.000 generated by the 452-nm, 523-nm, 591-nm, and 625-nm LEDs, respectively.

To a highest fraction of test colour samples rendered with increased chromatic saturation and the lowest fraction of test colour samples rendered with decreased chromatic saturation:

(B1) of about 77% and 1%, respectively, for a CCT of 3000 K, by selecting the RPRFs of 0.103, 0.370, 0.000, and 0.527 generated by the 452-nm, 523-nm, 591-nm, and 625-nm LEDs, respectively;

(B2) of about 70% and 0%, respectively, for a CCT of 4500 K, by selecting the RPRFs of 0.195, 0.401, 0.000, and 0.404 generated by the 452-nm, 523-nm, 591-nm, and 625-nm LEDs, respectively;

(B3) of about 67% and 2%, respectively, for a CCT of 6500 K, by selecting the RPRFs of 0.283, 0.392, 0.000, and 0.324 generated by the 452-nm, 523-nm, 591-nm, and 625-nm LEDs, respectively.

To about equal low fractions of test colour samples rendered with decreased chromatic saturation and with increased chromatic saturation:

(C1) of about 14% and 13%, respectively, for a CCT of 3000 K, by selecting the RPRFs of 0.126, 0.306, 0.279, and 0.289 generated by the 452-nm, 523-nm, 591-nm, and 625-nm LEDs, respectively;

(C2) of about 9% and 7%, respectively, for a CCT of 4500 K, by selecting the RPRFs of 0.224, 0.354, 0.219, and 0.203 generated by the 452-nm, 523-nm, 591-nm, and 625-nm LEDs, respectively;

(C3) of about 8% and 9%, respectively, for a CCT of 6500 K, by selecting the RPRFs of 0.318, 0.352, 0.184, and 0.146 generated by the 452-nm, 523-nm, 591-nm, and 625-nm LEDs, respectively.

Another example of the tailored white light source may comprise a dichromatic white LED with the SPD containing a blue and yellow components with the peak wavelengths of about 447 nm and 547 nm and band widths of about 18 nm and 120 nm, respectively, and three groups of coloured LEDs with the peak wavelengths of about 452 nm, 523 nm, and 637 nm and band width of about 20 nm, 32 nm, and 16 nm, respectively. For 1200 different test colour samples, such a source with a CCT of 6042 K can be adjusted:

To a highest fraction of test colour samples rendered with decreased chromatic saturation and a lowest fraction of test colour samples rendered with increased chromatic saturation of about 53% and 4%, respectively, by selecting the RPRFs of 1.000, 0.000, 0.000, and 0.000 generated by the white LED and 452-nm, 523-nm, and 637-nm LEDs, respectively;

To a highest fraction of test colour samples rendered with increased chromatic saturation and the lowest fraction of test colour samples rendered with decreased chromatic saturation of about 68% and 2%, respectively, by selecting the RPRFs of 0.000, 0.237, 0.366, and 0.397 generated by the white LED and 452-nm, 523-nm, and 637-nm LEDs, respectively;

To about equal low fractions of test colour samples rendered with decreased chromatic saturation and with increased chromatic saturation of about 14% and 13%, respectively, by selecting the RPRFs of 0.697, 0.071, 0.112, and 0.120 generated by the white LED and 452-nm, 523-nm, and 637-nm LEDs, respectively.

Further objects and advantages are to provide a design for the solid state white light sources with two opposing colour rendition characteristics controlled. Embodiments of the present invention may involve additional components such as, for instance,

(A) an electronic circuit for dimming the light source in such a way that the RPRFs generated by each group of emitters are maintained at constant values;

(B) an electronic and/or optoelectronic circuit for estimating the RPRFs generated by each group of emitters;

(C) a computer hardware and software for the control of the electronic circuits in such a way that allows varying CCT, trading off between the fractions of test colour samples that are rendered with decreased and increased chromatic saturation, maintaining a constant luminous output while trading off, dimming, and compensating thermal and aging drifts of each group of light emitters.

Polychromatic sources of white light with controlled colour saturating ability designed in accordance with the teachings of aspects and of the present invention can be used in general lighting applications where they can be adjusted to individual needs and preferences of colour vision, in merchandise, architectural, entertainment, medical, recreation, street, and landscape lighting for highlighting or dulling colours of various surfaces, as well as in other colour-quality sensitive applications, such as for filming, photography, and design and in medicine and psychology for treatment and prophylactics of seasonal affective disorder and other disorders affected by lighting quality.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims. For example, similar white light sources can be provided using lasers, with different number of colours rendered with decreased and increased chromatic saturation.

1-23. (canceled)

24. A solid-state source of white light, having a predetermined correlated colour temperature and a predetermined lowest luminous efficacy of radiation or lowest luminous efficiency, comprising at least one package of at least two groups of visible-light emitters having different spectral power distributions and individual relative partial radiant fluxes; an electronic circuit for the control of the average driving current of each group of emitters and/or the number of the emitters lighted on within a group; and a component for uniformly distributing radiation from the different groups of emitters over an illuminated object wherein the spectral power distributions and relative partial radiant fluxes generated by each group of emitters are such that, in comparison with a reference white light source having the same correlated colour temperature, when each of more than fifteen test colour samples resolved by an average human eye as different is illuminated, the colour saturating ability is controlled in such a way that both the fraction of the test colour samples that are rendered with increased saturation and the fraction of the test colour samples that are rendered with decreased saturation are predetermined and/or are dynamically traded off.

25. The light source of claim 24, wherein
the correlated colour temperature is set in the range of around 2500 to 10000 K;
the colour saturating ability is estimated with a chromatic adaptation of human vision taken into account; and/or
the emitters comprise light emitting diodes, which emit light due to injection electroluminescence in semiconductor junctions or due to partial or complete conversion of injection electroluminescence in wavelength converters containing phosphors.

26. The light source of claim 24 comprising at least three groups of visible-light emitters wherein the spectral power distributions and relative partial radiant fluxes generated by each said group of emitters are such that, in comparison with a reference light source, when each of more than fifteen test colour samples resolved by an average human eye as different is illuminated.

27. The light source of claim 26 wherein the relative partial radiant fluxes generated by each said group of emitters are such that the difference of the fraction of the test colour samples that are rendered with increased saturation and the fraction of the test colour samples that are rendered with decreased saturation is maximized.

28. The light source of claim 26 wherein said light source has correlated colour temperature in the interval of 2700-6500 K and luminous efficacy of radiation of at least 250 lm/W and comprises three groups of coloured light-emitting diodes with the average band width around 30 nm, having peak wavelengths within the intervals of around 408-486 nm, 509-553 nm, and 605-642 nm, when colours of at least 60% of more than 1000 different test colour samples are rendered with increased saturation and colours of at most 4% of the test colour samples are rendered with decreased saturation.

29. The light source of claim 28 wherein said three groups of coloured light-emitting diodes comprise blue electroluminescent InGaN light-emitting diodes with the peak wavelength of about 452 nm and band width of about 20 nm; green electroluminescent InGaN light-emitting diodes with the peak wavelength of about 523 nm and band width of about 32 nm; and red electroluminescent AlGaInP light-emitting diodes with the peak wavelength of about 625 nm and band width of about 15 nm, respectively, wherein for more than 1200 different test colour samples, the fraction of the samples that are rendered with increased saturation is maximized and the fraction of the samples that are rendered with decreased saturation is minimized:
(a) to about 77% and about 1%, respectively, for a correlated colour temperature of 3000 K, by selecting the relative partial radiant fluxes of 0.103, 0.370, and 0.527 generated by said 452-nm, 523-nm, and 625-nm light-emitting diodes, respectively;
(b) to about 70% and about 0%, respectively, for a correlated colour temperature of 4500 K, by selecting the relative partial radiant fluxes of 0.195, 0.401, and 0.405 generated by said 452-nm, 523-nm, and 625-nm light-emitting diodes, respectively;
(c) to about 67% and about 2%, respectively, for a correlated colour temperature of 6500 K, by selecting the relative partial radiant fluxes of 0.283, 0.392, and 0.325 generated by said 452-nm, 523-nm, and 625-nm light-emitting diodes, respectively.

30. The light source of claim 24 wherein the spectral power distributions and relative partial radiant fluxes generated by each said group of emitters are such that, in comparison with a reference light source, when each of more than fifteen test colour samples resolved by an average human eye as different is illuminated:
(a) colours of at least a predetermined fraction of the test colour samples are rendered with decreased saturation; and
(b) colours of at most another predetermined fraction of the test colour samples are rendered with increased saturation.

31. The light source of claim 30 wherein the relative partial radiant fluxes generated by each said group of emitters are such that the difference of the fraction of the test colour samples that are rendered with decreased saturation and the fraction of the test colour samples that are rendered with increased saturation is maximized.

32. The light source of claim 30 wherein said light source has correlated colour temperature in the interval of 2700-6500 K and luminous efficacy of radiation of at least 250 lm/W and comprises
(a) two groups of coloured light-emitting diodes with the average band width around 30 nm, having peak wavelengths within the intervals of around 405-486 nm and 570-585 nm, or
(b) three groups of coloured light-emitting diodes with the average band width around 30 nm, having peak wavelengths within the intervals of around 405-486 nm and 490-560 nm, and 585-600 nm,
when colours of at least 60% of 1000 different test colour samples are rendered with decreased saturation and of at most 4% of the test colour samples are rendered with increased saturation.

33. The light source of claim 32 wherein said three groups of coloured light-emitting diodes comprise blue electroluminescent InGaN light-emitting diodes with the peak wavelength of about 452 nm and band width of about 20 nm; green electroluminescent InGaN light-emitting diodes with the peak wavelength of about 523 nm and band width of about 32 nm; and amber electroluminescent AlGaInP light-emitting diodes with the peak wavelength of about 591 nm and band width of about 15 nm, respectively, wherein for more than 1200 different test colour samples, the fraction of the test colour samples that are rendered with decreased saturation is maximized and the fraction of the test colour samples that are rendered with increased saturation is minimized:
(a) to about 67% and 1%, respectively, for a correlated colour temperature of 3000 K, by selecting the relative partial radiant fluxes of 0.154, 0.228, and 0.618 generated by said 452-nm, 523-nm, and 591-nm light-emitting diodes, respectively;
(b) to about 58% and 1%, respectively, for a correlated colour temperature of 4500 K, by selecting the relative partial radiant fluxes of 0.254, 0.308, and 0.438 generated by said 452-nm, 523-nm, and 591-nm light-emitting diodes, respectively;
(c) to about 51% and 0%, respectively, for a correlated colour temperature of 6500 K, by selecting the relative partial radiant fluxes of 0.346, 0.320, and 0.334 generated by said 452-nm, 523-nm, and 591-nm light-emitting diodes, respectively.

34. The light source of claim 24 wherein said light source comprises at least three groups of visible-light emitters, the spectral power distributions and relative partial radiant fluxes generated by each said group of emitters being such that, in comparison with a reference light source, when each of more than fifteen test colour samples resolved by an average human eye as different is illuminated:
(a) colours of at most a predetermined fraction of the test colour samples are rendered with decreased saturation; and
(b) colours of at most another predetermined fraction of the test colour samples are rendered with increased saturation.

35. The light source of claim 34 wherein the relative partial radiant fluxes generated by each said group of emitters being selected such that both the fractions of the test colour samples that are rendered with increased and decreased chromatic saturation are minimized below a predetermined fraction.

36. The light source of claim 35 wherein said light source has correlated colour temperature in the interval of 2700-6500 K and luminous efficacy of radiation of at least 250 lm/W and comprises:
(a) three groups of coloured light-emitting diodes with the average band width around 30 nm, having peak wavelengths within the intervals of around 433-487 nm, 519-562 nm, and 595-637 nm, when the fractions of more than 1200 different test colour samples that are rendered with both decreased saturation and increased saturation are minimized to 14%, or
(b) four groups of coloured light-emitting diodes with the average band width around 30 nm, having peak wavelengths within the intervals of around 434-475 nm, 495-537 nm, 555-590 nm, and 616-653 nm, when the fractions of more than 1200 different test colour samples that are rendered with both decreased saturation and increased saturation are minimized to 2%.

37. The light source of claim 35 wherein said light source comprises three groups of coloured light-emitting diodes, such as blue electroluminescent InGaN light-emitting diodes with the peak wavelength of about 452 nm and band width of about 20 nm; cyan electroluminescent InGaN light-emitting diodes with the peak wavelength of about 512 nm and band width of about 30 nm; and amber phosphor converted InGaN light-emitting diodes with the peak wavelength of about 589 nm and band width of about 70 nm, wherein the fractions of more than 1200 different test colour samples that are rendered with both decreased saturation and increased saturation are minimized to:
(a) about 32% for a correlated colour temperature of 4500 K, by selecting the relative partial radiant fluxes of 0.207, 0.254, and 0.539 generated by said 452-nm, 512-nm, and 589-nm light-emitting diodes, respectively;
(b) about 15% for a correlated colour temperature of 6500 K, by selecting the relative partial radiant fluxes of 0.291, 0.280, and 0.429 generated by said 452-nm, 512-nm, and 589-nm light-emitting diodes, respectively; or
said light source comprises four groups of coloured light-emitting diodes, such as blue electroluminescent InGaN light-emitting diodes with the peak wavelength of about 452 nm and band width of about 20 nm; green electroluminescent InGaN light-emitting diodes with the peak wavelength of about 523 nm and band width of about 32 nm; amber phosphor converted InGaN light-emitting diodes with the peak wavelength of about 589 nm and band width of about 70 nm; and red AlGaInP light-emitting diodes with the peak wavelength of about 637 nm and band width of about 16 nm, wherein the fractions of more than 1200 different test colour samples that are rendered with both decreased saturation and increased saturation are minimized to:
(c) about 2% for a correlated colour temperature of 3000 K, by selecting the relative partial radiant fluxes of 0.112, 0.2255, 0.421, and 0.242 generated by said 452-nm, 523-nm, 589-nm, and 637-nm light-emitting diodes, respectively;
(d) about 3% for a correlated colour temperature of 4500 K, by selecting the relative partial radiant fluxes of 0.208, 0.283, 0.353, and 0.156 generated by said 452-nm, 523-nm, 589-nm, and 637-nm light-emitting diodes, respectively;
(e) about 4% for a correlated colour temperature of 6500 K, by selecting the relative partial radiant fluxes of 0.300, 0.293, 0.30, 5 and 0.102 generated by said 452-nm, 523-nm, 589-nm, and 637-nm light-emitting diodes, respectively.

38. The light source of claim 24 wherein the relative partial radiant fluxes generated by each said group of emitters are synchronously varied in such a way that in comparison with a reference light source, when each of more than fifteen test colour samples resolved by an average human eye as different is illuminated,
(a) the fraction of the test colour samples that are rendered with increased saturation, increases while the fraction of the test colour samples that are rendered with decreased saturation decreases; or
(b) the fraction of the test colour samples that are rendered with increased saturation, decreases while the fraction of the test colour samples that are rendered with decreased saturation increases.

39. The light source of claim 38 wherein the relative partial radiant fluxes generated by each said group of emitters are synchronously varied as a weighted sum of the relative partial radiant fluxes of the corresponding groups of emitters comprised in the light sources
(a) whose spectral power distributions and relative partial radiant fluxes generated by each said group of emitters are such that, in comparison with a reference light source, when each of more than fifteen test colour samples resolved by an average human eye as different is illuminated:
(i) colours of at least a predetermined fraction of the test colour samples are rendered with decreased saturation; and
(ii) colours of at most another predetermined fraction of the test colour samples are rendered with increased saturation; or
(b) whose relative partial radiant fluxes generated by each said group of emitters are such that the difference of the fraction of the test colour samples that are rendered with decreased saturation and the fraction of the test colour samples that are rendered with increased saturation is maximized.

40. The light source of claim 39 wherein said light source has correlated colour temperature in the interval of 2700-6500 K and luminous efficacy of radiation of at least 250 lm/W, the relative partial radiant fluxes generated by each said group of emitters being synchronously varied as a weighted sum of the corresponding relative partial radiant fluxes of the light sources previously defined having the preselected value of correlated colour temperature.

41. The light source of claim 39 wherein said light source has correlated colour temperature in the interval of 2700-6500 K and luminous efficacy of radiation of at least 250 lm/W and comprises four groups of coloured light-emitting diodes, such as blue InGaN light-emitting diodes with the peak wavelength of about 452 nm and band width of about 20 nm; green InGaN light-emitting diodes with the peak wavelength of about 523 nm and band width of about 32 nm; amber AlGaInP light-emitting diodes with the peak wavelength of about 591 nm and band width of about 15 nm; and red AlGaInP light-emitting diodes with the peak wavelength of about 625 nm and band width of about 15 nm, wherein the relative partial radiant fluxes generated by said each group of light-emitting diodes being synchronously varied as a weighted sum of the corresponding relative partial radiant fluxes of the light sources h having the same value of correlated colour temperature.

42. The light source of claim 39 wherein said light source has correlated colour temperature of about 6042 K and luminous efficacy of radiation of at least 250 lm/W and comprises four groups of light-emitting diodes, such as white dichromatic light-emitting diodes with partial conversion of radiation in phosphor; blue InGaN light-emitting diodes with the peak wavelength of about 452 nm and band width of about 20 nm; green InGaN light-emitting diodes with the peak wavelength of about 523 nm and band width of about 32 nm; and red AlGaInP light-emitting diodes with the peak wavelength of about 637 nm and band width of about 16 nm, wherein the relative partial radiant fluxes generated by each said group of light-emitting diodes being synchronously varied as a weighted sum of the corresponding relative partial radiant fluxes of the white light-emitting diodes and the trichromatic cluster composed of the blue, green, and red light-emitting diodes.

43. The light source of claim 24 wherein visible-light emitters within at least one of said groups are integrated semiconductor chips, wherein the spectral power distribution of the chips is adjusted by tailoring at least one of a chemical composition of an active layer or a thickness of the active layer forming each emitter or a chemical composition of phosphor contained in the wavelength converter or a thickness or shape of the wavelength converter.

44. The light source of claim 24 wherein said light source further comprises:
an electronic circuit for dimming the light source in such a way that the relative partial radiant fluxes generated by each group of emitters are maintained at constant values; and/or
an electronic and/or optoelectronic circuit for estimating the relative partial radiant fluxes generated by each group of emitters; and/or
a computer hardware and software for the control of the electronic circuits in such a way that allows varying correlated colour temperature and the fraction of test colour samples that are rendered with increased or decreased saturation, maintaining a constant luminous output while varying correlated colour temperature and the fraction of test colour samples that are rendered with increased or decreased saturation, dimming, and compensating thermal and aging drifts of each group of light emitters.

45. A method for dynamic tailoring the colour saturation ability wherein white light is generated by mixing emission from at least two sources of white light as defined in claim 24, having different colour saturation ability, the spectral power distribution of the mixed emission being synchronously varied as a weighted sum of the spectral power distributions of said constituent sources with variable weight parameters, which control the colour saturating ability.

46. The method of claim 45 wherein white light is generated by mixing emission from two sources of white light, having the same correlated colour temperature and each comprising at least one group of white emitters and/or at least two groups of coloured emitters, the spectral power distribution of the mixed emission, S_{σ}, being synchronously varied as a weighted sum of the spectral power distributions of said two constituent sources, S₁ and S₂, respectively, as
S_{σ}=σS₁+(1−σ)S₂, (1)
where σ is the variable weight parameter.
